(19) United States
(12) Patent Application Publication
(10) Pub. No.: US 2026/0043707 A1
(43) Pub. Date: Feb. 12, 2026

(54) GAS LEAK DETECTION APPARATUS

(71) Applicant: CKD CORPORATION, Komaki-shi (JP)

(72) Inventors: Takemoto KONDO, Komaki-shi (JP); Takaharu MATSUURA, Komaki-shi (JP); Shinji ITO, Komaki-shi (JP)

(73) Assignee: CKD CORPORATION, Komaki-shi (JP)

(21) Appl. No.: 19/270,753

(22) Filed: Jul. 16, 2025

(30) Foreign Application Priority Data
Aug. 8, 2024 (JP) 2024-133212

(51) Int. Cl. G01M 3/28

(52) U.S. Cl. CPC G01M 3/2815

(57) ABSTRACT

In a gas leak detection apparatus, a sealing switching valve, a releasing switching valve, and a pressure sensor are placed in this order from an upstream side in a pipe, which are connected to a main unit. An orifice is provided at an exhaust port of the releasing switching valve. The main unit measures a pipe volume based on an in-sealing pressure drop amount and an in-releasing pressure drop amount, measured by switching a pipe state using the switching valves to a gas supply state, a pipe sealing state, and a pipe pressure releasing state, and a leak amount from the orifice, estimated based on pipe pressure. The main unit measures a leak amount based on the measured pipe volume and an in-detecting pressure drop amount measured by switching the pipe state using the switching valves to the gas supply state and the pipe sealing state.

### CROSS-REFERENCE TO RELATED APPLICATIONS

This application is based upon and claims the benefit of priority to Japanese Patent Application No. 2024-133212 filed on Aug. 8, 2024, the entire contents of which are incorporated herein by reference.

### BACKGROUND

### Technical Field

The technical field disclosed in this specification relates to a gas leak detection apparatus for detecting a gas leak in a pipe.

### Related Art

A gas leak detection apparatus is configured, for example, to pressurize or depressurize a pipe under testing and, after a lapse of a certain time, detect a gas leak in the pipe based on pressure changes in the pipe. Gas leak can be detected based on a pipe volume and an amount of pressure change over a certain time. Therefore, accurate pipe volume is desired to detect a gas leak with high accuracy.

Piping layouts differ from user to user and therefore it is difficult to determine an accurate pipe volume before the gas leak detection apparatus is incorporated in the pipes. For this reason, some gas leak detection apparatus are incorporated in a pipe and then measure a flow rate, pressure, etc. by supplying gas to the pipe, and calculate a pipe volume based on measurement data and detect a gas leak based on the calculated pipe volume.

For example, Japanese unexamined patent application publication No. 1989-044824 (JP 1989-044824A) discloses an apparatus for measuring an air leak configured to pressurize a pipe to be measured and measure the pressure of the pipe, and then operate an air-blower to exhaust air from the pipe. This air leak measurement apparatus measures the pressure after a lapse of a predetermine time from the time of starting exhaust. Specifically, this air leak measurement apparatus estimates the pressure to be obtained after a lapse of the predetermined time from the exhaust starting time and a leakage pressure drop curve data stored in a memory. Further, the air leak measurement apparatus measures the amount of air blow by an integrating flow rate sensor and measures the temperature in the pipe. The air leak measurement apparatus calculates a pipe volume based on the pressure estimated from the time, and the measured temperature, pressure, air blow amount, and further calculates a leak amount based on the calculated pipe pressure and an amount of pressure drop for a predetermined time.

For example, Japanese unexamined patent application publication No. 1997-288031 (JP 1997-288031A) discloses an apparatus for measuring a gas leak amount configured to switch a pipe to be measured between a sealing state to seal the pipe and a releasing state to release gas from the pipe by opening and closing an exhaust port for opening the pipe to the atmosphere with a valve, connecting a tank to the pipe and controlling a connection state between the pipe and the tank with a cock. This leak amount measurement apparatus measures a pressure drop amount in a certain time in the sealing state and further measures the pressure drop amount in the certain time in the releasing state. Then, the gas leak amount measurement apparatus obtains a pipe volume from the data measured as above and further calculates a leak amount based on the obtained pipe volume and the pressure drop amount in the certain time in the sealing state.

For example, Japanese patent No. 4684135 (JP 4684135B2) discloses a leak test apparatus configured to supply a test gas to a pipe under testing in a sealing state to pressurize the pipe. This leak test apparatus detects a flow rate, pressure, and temperature of the test gas during pressurization, and calculates a pipe volume based on the time of pressurizing until the pressure in the pipe increases to a set value and the amount of the test gas supplied during that time. The leak test apparatus then calculates the amount of leakage (“leak amount”) from the pipe based on the pressure drop amount after a lapse of a predetermined pressure drop time from when the pipe is pressurized to the predetermined set pressure and the calculated pipe volume.

### SUMMARY

### Technical Problems

The air leak measurement apparatus disclosed in JP 1989-044824A and the leak test apparatus disclosed in JP 4684135B2 need the flow sensor for measuring the air blow amount or the flow rate, the valve for controlling the flow rate to the set value, and others. Thus, these apparatuses disclosed in JP 1989-044824A and JP 4684135B2 each have a large apparatus size.

The gas leak amount measurement apparatus disclosed in JP 1997-288031A can detect the pipe volume and the leak amount based on the pressure, but needs the valve for opening and closing the gas outlet, and the tank and the cock for changing the pipe volume. This apparatus also has a large apparatus size. Consequently, the conventional gas leak detection apparatus still needs in terms of reduction of apparatus size.

### Means of Solving the Problems

(1) To achieve the above-mentioned purpose, one aspect of the present disclosure provides a gas leak detection apparatus, which is placed in a pipe for supplying gas, to detect a gas leak in the pipe, the apparatus comprising: a gas supply valve to control supply of the gas; an exhaust valve placed on a downstream side of the gas supply valve, the exhaust valve being provided with an exhaust port and to control exhaust of the gas from the exhaust port; an orifice placed in the exhaust port to control an exhaust flow rate at a constant amount; a pressure sensor placed on a downstream side of the exhaust valve to measure a pipe pressure that is an internal pressure of the pipe; and a controller connected to the pressure sensor, the gas supply valve, and the exhaust valve to control operations of the gas supply valve and the exhaust valve, wherein the controller switches a pipe state of the pipe between: a gas supply state to supply the gas to the pipe to be measured by causing the gas supply valve to supply the gas and not causing the exhaust valve to exhaust the gas, a pipe sealing state to seal the pipe to be measured by causing the gas supply valve to shut off the gas and not causing the exhaust valve to exhaust the gas, and a pipe pressure releasing state to exhaust the gas from the pipe to be measured through the orifice by causing the gas supply valve to shut off the gas and causing the exhaust valve to exhaust the gas, and the controller executes: a pipe-volume measuring process in which the pipe state is switched to the gas supply state to pressurize the pipe to be measured, and then the pipe state is switched to the pipe pressure releasing state, and an in-releasing pressure drop amount, indicating an amount of pressure drop of the pipe pressure in the pipe pressure releasing state, until a measurement condition is satisfied is measured by the pressure sensor, and further the pipe state is switched to the pipe supply state to pressurize the pipe to be measured, and then the pipe state is switched to the pipe sealing state, and an in-sealing pressure drop amount, indicating an amount of pressure drop of the pipe pressure in the pipe sealing state, until the measurement condition is satisfied is measured by the pressure senor, and a pipe volume of the pipe to be measured is calculated based on the in-sealing pressure drop amount, the in-releasing pressure drop amount, and a leak amount from the orifice estimated from the pipe pressure; and a leak-amount measuring process in which the pipe state is switched to the gas supply state to pressurize the pipe to be measured, and then the pipe state is switched to the pipe sealing state, and an in-detecting pressure drop amount, indicating an amount of pressure drop of the pipe pressure during detecting, until the measurement condition is satisfied is measured, and the leak amount of the gas in the pipe to be measured is calculated based on the pipe volume calculated in the pipe-volume measuring process and the in-detecting pressure drop amount.

In the gas leak detection apparatus configured as above, the gas to be exhausted through the exhaust port is controlled at a constant amount by the orifice placed in the exhaust port of the exhaust valve. The amount of gas leak from the orifice and the pipe pressure are in a proportional relationship. Thus, the gas leak detection apparatus can estimate the leak amount from the orifice based on the pipe pressure, even if a flowmeter and a flow control valve are not connected to the exhaust port. The gas leak detection apparatus switches the pipe state of the pipe to the gas supply state, the pipe pressure releasing state, and the pipe sealing state by use of the gas supply valve and the exhaust valve and measures the in-releasing pressure drop amount (i.e., the amount of pressure drop of the pipe pressure in the pipe pressure releasing state) and the in-sealing pressure drop amount (i.e., the amount of pressure drop of the pipe pressure in the pipe sealing state), and calculates the pipe volume based on those measured data and the leak amount from the orifice estimated from the pipe pressure. Further, the gas leak detection apparatus switches the pipe state of the pipe to the gas supply state and the pipe sealing state by use of the gas supply valve and the exhaust valve and measures the in-detecting pressure drop amount (i.e., the amount of pressure drop of the pipe pressure during detecting?), and calculates the leak amount from the pipe based on those measured data and the calculated pipe volume. Therefore, the gas leak detection apparatus configured as above can calculate the pipe volume based on only the pressure measured by the pressure sensor and detect a gas leak by use of the calculated pipe volume, even if a flowmeter and a flow control valve are not connected to the exhaust port. This apparatus can therefore have a reduced apparatus size.
(2) In the gas leak detection apparatus described in (1), the measurement condition may be to satisfy either a condition that a pressure drop time, indicating a period of time for measuring a pressure drop amount of the pipe pressure, exceeds a time threshold value or a condition that the pressure drop amount is larger than a pressure threshold value.

The gas leak detection apparatus configured as above terminates measurement of the pressure drop amount when the pressure drop amount is larger than the pressure threshold value even though the pressure drop time period does not exceed the time threshold value in the pipe-volume measuring process or the leak-amount measuring process. Accordingly, the gas leak detection apparatus can stop the measurement of the pressure drop amount, for example, before an error, i.e., a difference, between an estimated value of the leak amount from the orifice and an actual leak amount from the orifice becomes larger than an allowable range. Therefore, the measurement accuracy of the pipe volume and the leak amount can be improved.
(3) In the gas leak detection apparatus described in (2), the pressure threshold value may be set at a value equal to or less than 10% of an original pressure of the gas.

In the gas leak detection apparatus configured as above, the pressure threshold value is set to 10% or less of the original pressure of the gas. This can improve the measurement accuracy of the pipe volume and the leak amount. This is because if the pressure threshold value is a value exceeding 10% of the gas original pressure, an error between the estimated value of the leak amount from the orifice and the actual leak amount from the orifice will become large, which may reduce the measurement accuracy of the pipe volume and the leak amount.
(4) The gas leak detection apparatus described in (2) or (3), may include a measurement condition selecting table in which the time threshold value is stored in association with a pipe volume and a leak determination threshold value that is set in advance, and the controller may set the time threshold value selected from the measurement condition selecting table to the time threshold value of the measurement condition used in the leak-amount measuring process.

In the gas leak detection apparatus configured as above, the time threshold value is selected from the measurement condition selecting table according to the pipe volume and the leak determination threshold value, so that the leak amount can be calculated using an optimal time threshold value. This can improve the measurement accuracy of the leak amount.
(5) The gas leak detection apparatus described in any one of (1) to (4) may further include a storage part, wherein the controller may execute a first operation detecting process to detect a first operating state of at least one direction switching valve according to a state of the pipe to be measured in the pipe-volume measuring process, and wherein, in the pipe-volume measuring process, the controller may store the calculated pipe volume in the storage part in association with the first operating state detected in the first operation detecting process.

In the gas leak detection apparatus configured as above, the pipe volume calculated in association with the pipe to be measured is stored in the storage part. Thus, this apparatus can use the pipe volume of the pipe to be measured during measurement of leak amount by reading out this pipe volume from the storage part, and can detect a gas leak for each pipe with high accuracy.
(6) In the gas leak detection apparatus described in (5), the controller may execute a second operation detecting process to detect a second operating state of the at least one direction switching valve according to a state of the pipe to be measured in the leak-amount measuring process, in the leak-amount measuring process, the controller may store the calculated leak amount in the storage part in association with the second operating state detected in the second operation detecting process, and the controller may further execute an output process to output information related to a leak based on the leak amount stored in the storage part.

In the gas leak detection apparatus configured as above, the leak amount calculated in association with the pipe to be measured is stored in the storage part and the information on a leak in each of the pipes based on the stored leak amount is output. This configuration can give a notice of a gas leak for each pipe.
(7) The gas leak detection apparatus described in any one of (1) to (6) may be configured such that the pipe includes a gas supply pipe for supplying the gas and a plurality of branch pipes branching off from the gas supply pipe, a direction switching valve is placed in the pipe to control a flow of the gas from the gas supply pipe to the plurality of branch pipes, and the gas supply valve, the exhaust valve, and the pressure sensor are placed in the gas supply pipe.

In the gas leak detection apparatus configured as above, the gas supply valve is provided separately from the direction switching valve. This apparatus can therefore measure the pipe volume and the leak amount for each pipe with a small number of devices and easily locate or localize a leak site.
(8) The gas leak detection apparatus described in any one of (1) to (6) may be configured such that the pipe includes a gas supply pipe for supplying the gas and a plurality of branch pipes branching off from the gas supply pipe, a direction switching valve is placed in the pipe to control a flow of the gas from the gas supply pipe to the plurality of branch pipes, the gas supply valve is the direction switching valve, the exhaust valve is connected to the plurality of branch pipes connected to the direction switching valve, and the pressure sensor includes a plurality of pressure sensors each placed in one of the plurality of branch pipes.

In the gas leak detection apparatus configured as above, the direction switching valve includes the function of switching a flow of gas and the function of sealing the pipe to be measured. This apparatus can therefore calculate the pipe volume and the leak amount for each of the branch pipes and easily locate a leak site.

A control method, a computer program, and a computer-readable storage medium that stores the computer program to achieve the functions of the above-configured apparatus are also novel and useful.

According to the above-identified configuration, a gas leak detection apparatus can be achieved with a reduced apparatus size to measure a pipe volume by forcibly exhaust gas from a pipe, measure a pipe volume, and detect a gas leak in the pipe based on the measured pipe volume.

### BRIEF DESCRIPTION OF THE DRAWINGS

FIG. 1 is a diagram showing a schematic configuration of a gas leak detection apparatus in a first embodiment;

FIG. 2 is a diagram showing an electrical configuration of a main unit;

FIG. 3 is a table showing pipe states;

FIG. 4 is a graph showing one example of orifice leak information;

FIG. 5 is a graph showing a relationship between measurement time and pipe pressure;

FIG. 6 is a graph showing a relationship between measurement time and pipe pressure;

FIG. 7 is one example of a measurement condition selecting table;

FIG. 8A is a flowchart showing one example of a control procedure of a pipe-volume measuring process and a leak-amount measuring process;

FIG. 8B is a flowchart showing one example of a control procedure of the leak-amount measuring process;

FIGS. 9A to 9C are flowcharts showing one example of the control procedure of the leak-amount measuring process;

FIG. 10 is a flowchart showing one example of a control procedure of an output process;

FIG. 11 is a diagram showing an application example of the gas leak detection apparatus in the first embodiment;

FIG. 12 is a diagram showing a schematic configuration of a gas leak detection apparatus in a second embodiment;

FIG. 13 is a table showing a relationship between switching valve state and pipe state; and

FIG. 14 is a diagram showing an application example of the gas leak detection apparatus in the second embodiment.

### DETAILED DESCRIPTION OF THE EXEMPLARY EMBODIMENTS

A detailed description of embodiments of a gas leak detection apparatus of this disclosure will now be given referring to the accompanying drawings. The following embodiments disclose a gas leak detection apparatus to detect a leak in a supply line for supplying gas and compressed air.

### First Embodiment

### Schematic Configuration of Pneumatic System

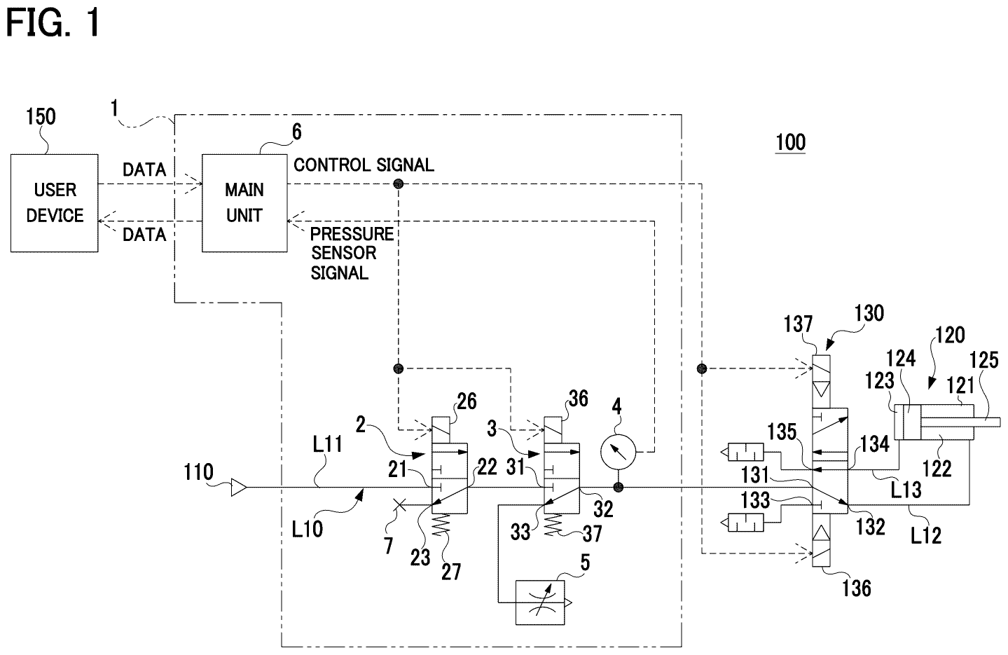

As shown in FIG. 1, a gas leak detection apparatus in the first embodiment is incorporated in a pneumatic system 100 and detects a leak in a pipe L10 for supplying compressed air. The pneumatic system 100 is provided with a direction switching valve 130 on the pipe L10 for supplying compressed air from a gas supply source 110 to a pneumatic actuator 120. The compressed air is one example of “gas” of the present disclosure. In FIG. 1, a switching valve 2 used for sealing (hereinafter, a sealing switching valve 2) is in a “shut-off state” to seal the pipe L10. A switching valve 3 used for releasing (hereinafter, a releasing switching valve 3) is in an “exhaust state” to exhaust the compressed air from the pipe L10. The direction switching valve 130 placed on the pipe L10 is in a state of supplying the compressed air to a first chamber 122.

The pneumatic actuator 120 has a piston 124 slidably installed in a cylinder 121. This cylinder 121 is hermetically partitioned by the piston 124 into the first chamber 122 and a second chamber 123. The piston 124 is joined to a drive rod 125. The drive rod 125 is inserted in the cylinder 121 with its distal end protruding out of the cylinder 121. The pneumatic actuator 120 is configured such that the drive rod 125 retracts into the cylinder 121, i.e., moves leftward in the figure, when the first chamber 122 is pressurized, and the drive rod 125 protrudes out from the cylinder 121, i.e., moves rightward in the figure, when the second chamber 123 is pressurized.

The direction switching valve 130 is provided with an input port 131, a first output port 132, a first exhaust port 133, a second output port 134, and a second exhaust port 135. The direction switching valve 130 changes over a flow of compressed air according to energization of a first solenoid 136 and a second solenoid 137.

Specifically, when the first solenoid 136 is energized and the second solenoid 137 is not energized, the direction switching valve 130 operates to connect the input port 131 to the first output port 132 and connect the second output port 134 to the second exhaust port 135. Accordingly, the direction switching valve 130 is switched to a “first output position” to output compressed air from the first output port 132.

In contrast, when the first solenoid 136 is not energized and the second solenoid 137 is energized, the direction switching valve 130 operates to connect the input port 131 to the second output port 134 and connect the first output port 132 to the first exhaust port 133. Accordingly, the direction switching valve 130 is switched to a “second output position” to output the compressed air from the second output port 134.

The pipe L10 includes a gas supply pipe L11, a first branch pipe L12, and a second branch pipe L13. The gas supply pipe L11 connects the gas supply source 110 to the input port 131 of the direction switching valve 130 to supply the compressed air to the direction switching valve 130. The first branch pipe L12 connects the first output port 132 of the direction switching valve 130 to the first chamber 122 of the pneumatic actuator 120 to supply the compressed air to the first chamber 122. The second branch pipe L13 connects the second output port 134 of the direction switching valve 130 to the second chamber 123 of the pneumatic actuator 120 to supply the compressed air to the second chamber 123.

### Schematic Configuration of Gas Leak Detection Apparatus

The gas leak detection apparatus 1 in the present embodiment is placed on the upstream side of the direction switching valve 130, that is, on the gas supply pipe L11. In the gas leak detection apparatus 1, pipe to be measured, which are measuring objects, are changed over according to the operations of the direction switching valve 130. The gas leak detection apparatus 1 includes the sealing switching valve 2, the releasing switching valve 3, a pressure sensor 4, the orifice 5, and a main unit 6.

The sealing switching valve 2 controls supply of gas by opening and closing the gas supply pipe L11. The releasing switching valve 3 is placed on a downstream side of the sealing switching valve 2 and is provided with an exhaust port 33. The releasing switching valve 3 controls exhaust of gas from the exhaust port 33. In the exhaust port 33, the orifice 5 is provided. The pressure sensor 4 is placed on a downstream side of the releasing switching valve 3 and detects the pipe pressure that is an internal pressure of the pipe L10.

The main unit 6 is a well-known micro-computer, which is connected to the sealing switching valve 2, the releasing switching valve 3, and the pressure sensor 4. The main unit 6 is connected to a user device 150 that manages the pneumatic system 100 to transmit/receive data to/from the user device 150. The main unit 6 detects the pipe pressure based on a pressure sensor signal output by the pressure sensor 4 and accordingly controls the operations of the sealing switching valve 2 and the releasing switching valve 3. This main unit 6 will be described later. The sealing switching valve 2 is one example of a “gas supply valve” of the disclosure. The releasing switching valve 3 is one example of an “exhaust valve” of the disclosure. The main unit 6 is one example of a “controller” of the disclosure.

The sealing switching valve 2 and the releasing switching valve 3 in the present embodiment are configured similarly except for a seal plug 7 and the orifice 5. Specifically, the sealing switching valve 2 is provided with an input port 21, an output port 22, and an exhaust port 23 and similarly the releasing switching valve 3 is provided with an input port 31, an output port 32, and an exhaust port 33. The sealing switching valve 2 and the releasing switching valve 3 are each switched between a “gas supply position” and an “exhaust position” according to energization of the solenoids 26 and 36 to switch a flow of compressed air.

When the solenoids 26 and 36 are energized and turned ON, the sealing switching valve 2 and the releasing switching valve 3 are switched to the gas supply position against springs 27 and 37 to allow communication between the input port 21 and the output port 22 and between the input port 31 and the output port 32, respectively. In contrast, when the solenoids 26 and 36 are not energized and are turned OFF, the sealing switching valve 2 and the releasing switching valve 3 are switched to the exhaust position under the urging forces of the springs 27 and 37 to allow communication between the output port 22 and the exhaust port 23 and between the output port 32 and the exhaust port 33, respectively. When the solenoids 26 and 36 are released from energization and changed from ON to OFF, the sealing switching valve 2 and the releasing switching valve 3 automatically return to the exhaust position under the urging forces of the springs 27 and 37.

In the sealing switching valve 2, the input port 21 is connected to the gas supply source 110 and the output port 22 is connected to the releasing switching valve 3. The exhaust port 23 is closed by the seal plug 7. When positioned in the gas supply position, the sealing switching valve 2 opens the pipe L10 to supply compressed air to the releasing switching valve 3. When positioned in the exhaust position, the sealing switching valve 2 does not allow the compressed air to be exhausted from the exhaust port 23. Thus, the pipe L10 is shut off and no compressed air is supplied to the releasing switching valve 3.

In the releasing switching valve 3, the input port 31 is connected to the output port 22 of the sealing switching valve 2, the output port 32 is connected to the input port 131 of the direction switching valve 130, the exhaust port 33 is open to the atmosphere via the orifice 5. When positioned in the gas supply position, the releasing switching valve 3 closes the exhaust port 33, allowing no exhaust, and outputs the compressed air to the direction switching valve 130. When positioned in the exhaust position, the releasing switching valve 3 exhausts the compressed air via the orifice 5 and does not output the compressed air to the direction switching valve 130. The orifice 5 may be detachably provided. During non-execution of leak measurement, the orifice 5 may be detached so that the releasing switching valve 3 is used as a normal residual-pressure releasing valve.

The orifice 5 controls an exhaust flow rate of the compressed air to be exhausted from the exhaust port 33 to a constant flow rate. The leak amount from the orifice 5 will be described later.

The sealing switching valve 2 only needs to have the function of controlling gas supply and may be a valve of a different type or structure from the releasing switching valve 3, such as a poppet 2-port valve. However, when the sealing switching valve 2 and the releasing switching valve 3 are identical in structure, the gas leak detection apparatus 1 uses fewer types of valves and thus can achieve cost reduction.

### Electrical Configuration of Main Unit

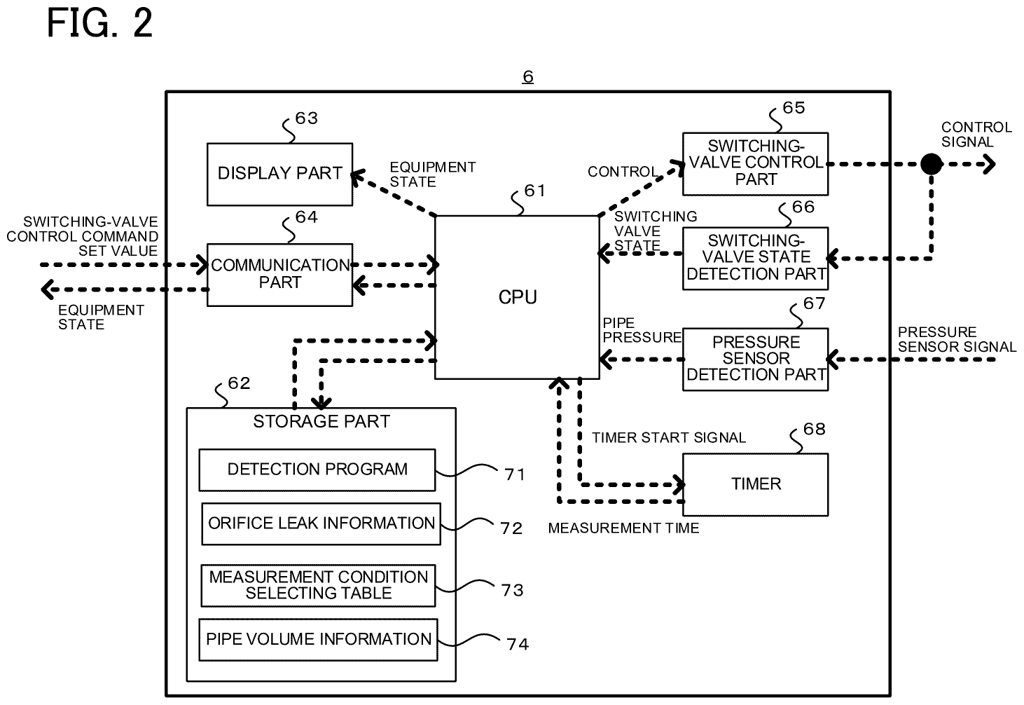

The electrical configuration of the main unit 6 will be described below with reference to FIG. 2. In the main unit 6, a CPU 61 is connected to a storage part 62. The main unit 6 includes a display part 63, a communication part 64, a switching-valve control part 65, a switching-valve state detection part 66, a pressure-sensor detection part 67, and a timer 68, each of which is connected to the CPU 61.

The CPU 61 executes various processes according to a program read out from the storage part 62 and based on user's operations. The storage part 62 stores various programs including a detection program 71 and various data including orifice leak information 72, a measurement condition selecting table 73, and pipe volume information 74.

The detection program 71 is a program to cause the CPU 61 of the gas leak detection apparatus 1 to measure a pipe volume and a leak amount by switching a pipe state of the pipe L10 using the sealing switching valve 2 and the releasing switching valve 3. This switching of the pipe state, the process of measuring the pipe volume, and the process of measuring the leak amount will be described later.

The orifice leak information 72 includes leak amounts from the orifice 5 and pipe pressures, which are stored in association with each other. This orifice leak information 72 is stored for each type of the orifice 5. The types of the orifices 5 are for example an orifice diameter and a leak amount. The measurement condition selecting table 73 includes pipe volumes, leak amounts, and time threshold values, which are stored in association with each other. The time threshold value is a threshold indicating an upper limit of the period of time for measuring a pressure drop amount (herein, referred to as “pressure drop time”). The time threshold value is one example of a “measurement condition” of the disclosure. The pipe volume information 74 includes the pipe volumes measured by the detection program 71. The orifice leak information 72, the measurement condition selecting table 73, and the pipe volume information 74 will be described later.

The display part 63 informs a user of the information. The display part 63 is for example an LED lamp or a liquid crystal display. The display part 63 may be provided with switches that have an operational function in addition to a display function. For example, the display part 63 receives an equipment state, such as the presence/absence of leaks and the leak amounts, from the CPU 61 and displays that state. Further, when the leak amount of a pipe under measurement exceeds a leak determination threshold value, the display part 63 can display an abnormal state to inform a user thereof. The leak determination threshold value is a threshold set in advance by the user to determine whether a leak occurs in the pipe to be measured.

The communication part 64 includes an interface for controlling communications with an external device, such as a user device 150. The communication part 64 may transmit, from the user device 150 to the CPU 61, for example, a switching-valve control command output from the user device 150 to the direction switching valve 130 and various set values, such as an original pressure of gas in the gas supply source 110 and a leak determination threshold value. The communication part 64 may also transmit, from the CPU 61 to the user device 150, various data, such as the equipment state, leak amounts, and pressure values. A communication method of the communication part 64 can be either wired or wireless. The communication part 64 may use a combination of two or more types of communication methods.

The switching-valve control part 65 is communicatively connected to each of the sealing switching valve 2, the releasing switching valve 3, and the direction switching valve 130. The switching-valve control part 65 transmits control signals to control the operations of the sealing switching valve 2, releasing switching valve 3, and direction switching valve 130 according to control by the CPU 61 that runs the detection program 71.

The switching-valve state detection part 66 obtains a control signal output from the switching-valve control part 65 and transmits switching-valve states representing the operating states of the sealing switching valve 2, releasing switching valve 3, and direction switching valve 130 to the CPU 61. The switching-valve state detection part 66 may query those sealing switching valve 2, releasing switching valve 3, and direction switching valve 130 for respective states, and transmit the switching-valve states based on their responses to the CPU 61.

The pressure-sensor detection part 67 obtains a pressure sensor signal output by the pressure sensor 4 and transmits the pipe pressure of the pipe L10 to the CPU 61. The timer 68 starts measuring the time upon receipt of a time measuring signal from the CPU 61, and transmits a measured time from the start of measurement to the present time to the CPU 61.

### Switching of Pipe State

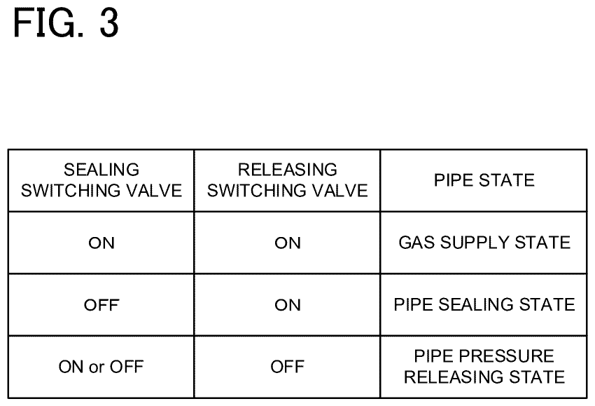

Switching of the pipe state will be described below with reference to FIG. 3. The pipe state of the pipe L10 is switched between a “gas supply state”, a “pipe sealing state”, and a “pipe pressure releasing state” according to the operations of the sealing switching valve 2 and the releasing switching valve 3.

When the sealing switching valve 2 and the releasing switching valve 3 are turned ON, the pipe state is switched to the gas supply state to allow the compressed air to flow through the pipe L10. When the sealing switching valve 2 is turned OFF and the releasing switching valve 3 is turned ON, the pipe state is switched to the pipe sealing state to form a sealed space in the pipe L10. When the releasing switching valve 3 is turned OFF, the pipe state is switched to the pipe pressure releasing state to exhaust the compressed air from the pipe L10. In this state, the pipe L10 is shut off by the releasing switching valve 3 turned ON and therefore the detection program 71 may control the sealing switching valve 2 to either state, ON or OFF.

### Method of Measuring Pipe Volume and Leak Amount

The gas leak detection apparatus 1 in the present embodiment pressurizes a pipe to be measured and then measures a pressure drop amount after a lapse of a fixed time, and measures a pipe volume and a leak amount based on the measured pressure drop amount.

For example, the following conditions are assumed: Q₁ is a leak amount (L/min) of the pneumatic system 100; Q₂ is a leak amount (L/min) from the orifice 5; V is a pipe volume of a pipe to be measured; PR is a supply source pressure (MPa); ΔP₁ is a pressure drop amount (MPa) measured in the pipe sealing state; ΔP₂ is a pressure drop amount (MPa) measured in the pipe pressure releasing state; P₀ is a constant number, in which P₀ in the present embodiment is set at 0.1013 MPa; T₁ is a pressure drop time (sec) measured in the pipe sealing state; and T₂ is a pressure drop time (sec) measured in the pipe pressure releasing state.

In this case, the leak amount Q₁ of the pneumatic system 100, i.e., the leak amount Q₁ of gas that leaks from a leak site when the pipe to be measured is placed in the pipe sealing state, can be calculated by the following equation I:

$${Q}_{1} - V \times \frac{Δ {P}_{1}}{{P}_{0}} \times \frac{60}{{T}_{1}} . \qquad ( I )$$

In contrast, when the pipe state is in the pipe pressure releasing state and the gas is forcibly exhausted from the exhaust port 33, the leak amount is obtained by adding together the leak amount Q₁ of the pneumatic system 100 (i.e., the leak amount from a leak site) and the leak amount Q₂ from the orifice 5 (i.e., the exhaust flow rate from the exhaust port 33). The leak amount during forcible exhaust, i.e., Q₁+Q₂, can be calculated by the following equation II:

$${Q}_{1} + {Q}_{2} = V \times \frac{Δ {P}_{2}}{{P}_{0}} \times \frac{60}{{T}_{2}} . \qquad ( II )$$

By substituting the equation I into the equation II, the following equation III for calculating a pipe volume V is obtained:

$$V = \frac{{P}_{0} \times {Q}_{2}}{Δ {P}_{2} \times \frac{60}{{T}_{2}} - Δ {P}_{1} \frac{60}{{T}_{1}}} . \qquad ( III )$$

The gas leak detection apparatus 1 can calculate the pipe volume V using the equation III based on the leak amount Q₂ from the orifice 5 (i.e., the exhaust flow rate from the exhaust port 33) and the pipe pressure detected by the pressure sensor 4.

### Orifice Leak Information

To measure a pressure drop amount, conventionally, the pressure is measured by a pressure sensor and further the exhaust flow rate is controlled at a constant flow rate by a flow sensor and a flow control valve. In contrast, the gas leak detection apparatus 1 in the present embodiment includes the orifice 5 placed in the exhaust port 33, and controls the exhaust flow rate at a constant flow rate using the orifice 5 without using a flowmeter, a flow control valve, and others. The leak amount Q₂ from the orifice 5 depends on the pipe pressure (the primary side pressure). In the gas leak detection apparatus 1 in the present embodiment, therefore, the storage part 62 stores the orifice leak information 72 having the leak amounts from the orifice 5 and the pipe pressures, which are stored in association with each other.

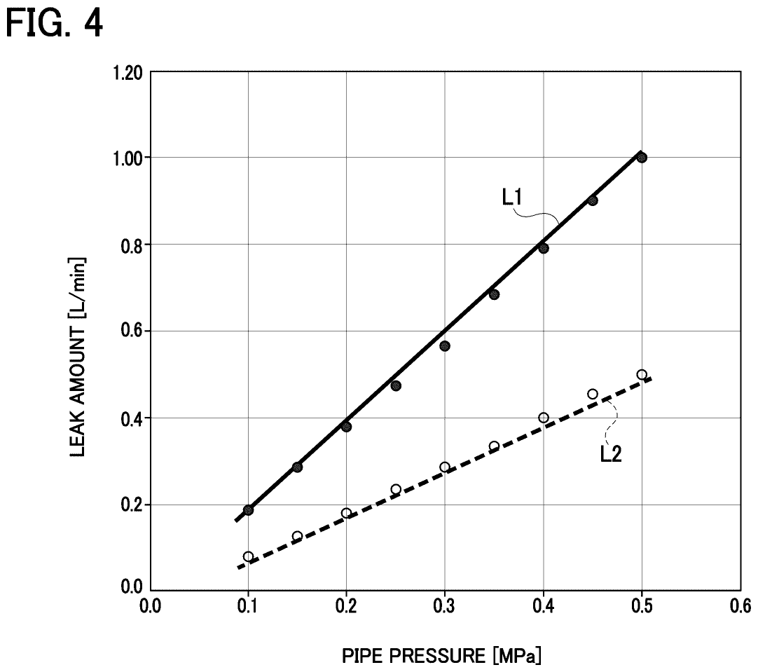

One example of the orifice leak information 72 will be described below with reference to FIG. 4. In FIG. 4, the vertical axis indicates a leak amount (L/min) and the horizontal axis indicates a pipe pressure (MPa). In FIG. 4, black circles are actual measured values of the leak amount from a first orifice, obtained by changing the pipe pressure (the primary side pressure) acting on the first orifice, the solid line L1 is an approximate line of the actual measured values indicated by the black circles, white circles are actual measured values of the leak amount from a second orifice having a different diameter from the first orifice, actually measured by changing the pipe pressure (the primary side pressure) acting on the second orifice, and the broken line L2 is an approximate line of the actual measured values indicated by the white circles.

As indicated by the lines L1 and L2 in FIG. 4, the leak amount from the orifice 5 tends to increase in proportion to a rise in pipe pressure, regardless of differences in orifice diameter. The larger the orifice diameter, the greater the increasing rate of the leak amount with respect to the pipe pressure. For example, when the orifice diameter of the first orifice is set to cause a leak amount of 1.0 L/min for a pipe pressure of 0.5 MPa and the orifice diameter of the second orifice is set to cause a leak amount of 0.5 L/min for a pipe pressure of 0.5 MPa, the leak amount from the first orifice is twice the leak amount from the second orifice under the same pipe pressure.

Thus, the gas leak detection apparatus 1 can adjust an exhaust flow rate of compressed air to be exhausted from the exhaust port 33 of the releasing switching valve 3 by changing the types (orifice diameter, leak amount) of the orifice 5, even if a flow control valve is not connected to the exhaust port 33. Further, the types of the orifice 5 are selected to provide a leak amount near a leak determination threshold value. This leak determination threshold value will be described later.

The gas leak detection apparatus 1 in the present embodiment stores, as the orifice leak information 72, the relationship between the pipe pressure and the leak amount for each type (in the present embodiment, orifice diameter) of the orifice 5 as indicated by the lines L1 and L2 in FIG. 4. Even if a flowmeter is not connected to the exhaust port 33, the gas leak detection apparatus 1 can estimate the leak amount Q₂, that is, the exhaust flow rate from the exhaust port 33 or the leak amount from the object under measurement, by checking the type of the orifice 5 placed in the exhaust port 33 and the pipe pressure measured by the pressure sensor 4, against the orifice leak information 72.

### Conditions for Measuring Pressure

The conventional gas leak detection apparatus has no limit on the pressure drop amount, and only the time threshold value is used as a measurement condition for measuring the pressure. However, the gas leak detection apparatus 1 in the present uses not only the time threshold value but also the upper limit of pressure drop amount (the pressure threshold value) as measurement conditions. The reason for using two types of measurement conditions is as follows.

### Pressure Threshold Value

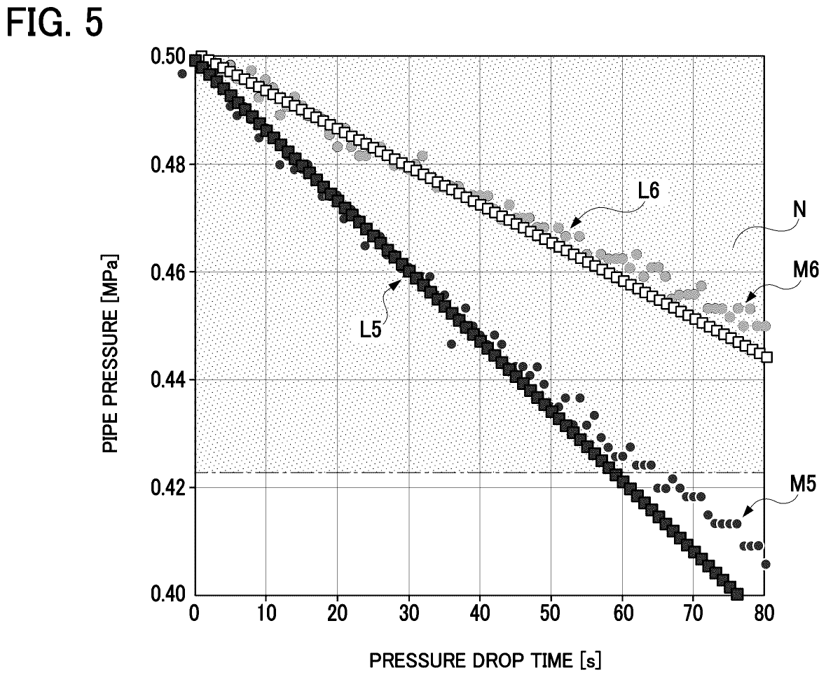

FIG. 5 is a graph showing the relationship between the pressure drop time and the pipe pressure in the cases where the leak amount from an object to be measured (hereinafter, “measuring object”) is 1.0 L/min and 0.5 L/min. In this graph, the vertical axis indicates the pipe pressure (MPa) and the horizontal axis indicates the pressure drop time(s). In FIG. 5, black circles M5 are actual measured values of the pipe pressure repeatedly taken at a predetermined sampling interval for a leak amount of 1.0 L/min. In FIG. 5, black diamond-shaped marks L5 are the linear approximate values calculated by the linear approximate equation from the data of the pipe pressure between 0.5 MPa and 0.47 MPa, among the actual measured values indicated by the black circles M5. In FIG. 5, gray circles M6 are actual measured values of the pipe pressure repeatedly taken at a predetermined sampling intervale for a leak amount of 0.5 L/min. In FIG. 5, white diamond-shaped marks L6 are the linear approximate values calculated by the linear approximate equation from the data of the pipe pressure between 0.5 MPa and 0.47 MPa, among the actual measured values indicated by the gray circles in FIG. 5.

In FIGS. 5, M5 and M6 are the actual measured values (pressure sampling data) of the pressure drop amount when the leak amount from the measuring object is 1.0 L/min and 0.5 L/min, respectively. In contrast, L5 and L6 are the estimated values calculated by the linear approximate equation from the data of the pipe pressure between 0.5 MPa and 0.47 MPa, among the actual measured values M5 and M6. The leak amount of the measuring object decreases as the pipe pressure decreases. Thus, the time it takes for the pressure drop due to outflow of compressed air from the orifice 5 is longer, as the pipe pressure is lower. Accordingly, M5 and M6 in the figure deviate from L5 and L6 in a smaller direction as the pipe pressure is lower. Therefore, when a large pressure threshold value relative to the supply pressure is set, an error between the linear approximate value and the actual measured value becomes larger. This may reduce the measurement accuracy of the pipe volume and the leak amount.

Then, the gas leak detection apparatus 1 in the present embodiment sets the pressure threshold value in a range as close as possible to the supply pressure and an error due to pressure drop is small, and terminates the pressure measurement when the actual measured value of the pressure drop amount exceeds the pressure threshold value even before the predetermined time threshold value elapses.

If the pressure threshold value is small, the measurement time of the pressure drop will be short. Thus, the number of pressure values obtained from the pressure sensor 4 is small, resulting in less measurement accuracy. It is therefore desirable to appropriately set the pressure threshold value to a value at which the predetermined number or more of data can be obtained from the pressure sensor 4, according to the accuracy of the pressure sensor used and the variation in pressure drop time due to the degree of the leak amount of the measuring object.

In the present embodiment, the upper limit (the pressure threshold value) of the pressure drop amount is set to a value in the range N, which is less than 10% of the original pressure of gas in the gas supply source 110 (e.g., 0.5 MPa to 0.47 MPa), as shown in FIG. 5. If a pressure drop amount larger than 10% of the original pressure is set as the pressure threshold value, a measurement error due to a decrease in leak amount resulting from the pressure drop is large, and the pipe volume and the leak amount may not be measured accurately. However, if the measured leak amount is large or the volume of the measuring object is small, which may reduce the measurement accuracy due to a very shortened pressure drop time, a pressure drop amount larger than 10% of the original pressure may be set as the pressure threshold value.

The pressure threshold value in the present embodiment is more preferably set to a value falling within a range of 6% to 8% inclusive of the original pressure of gas in the gas supply source 110. This is because when a value less than 6% of the gas original pressure is set as the pressure threshold value, the pressure sampling data will be less and the measurement accuracy of the pipe volume and the leak amount will be low. Further, when a value larger than 8% of the gas original pressure is set as the pressure threshold value, an error between the estimated value of the leak amount from the orifice and the actual leak amount from the orifice will be large, and the measurement accuracy of the pipe volume and the leak amount will be low.

### Time Threshold Value

As shown in FIG. 5, the smaller the leak amount from the measuring object, the smaller the pressure drop rate. The time required for the pressure drop amount of the pipe pressure to reach the pressure threshold value depends on the leak amount of the measuring object. For example, when the pressure threshold value is 0.03 MPa, the time it takes for the pipe pressure to decrease from 0.5 MPa to 0.47 MPa is about 25 (s) in the case of L5 for a large leak amount, and about 45 (s) in the case of L6 for a smaller leak amount than L5. If the time threshold value is set based on the case of L5 for the large leak amount, the measurement in the case of L6 for the small leak amount will be terminated before the pressure drop amount reaches the pressure threshold value. The gas leak detection apparatus 1 therefore needs to set a suitable time threshold value for a leak amount of the measuring object.

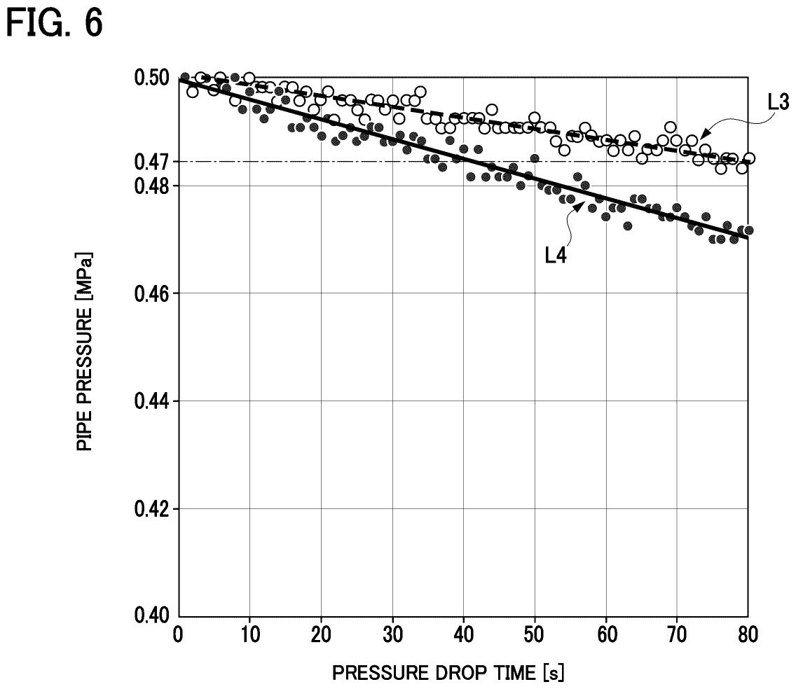

FIG. 6 is a diagram showing the relationship between the pressure drop time and the pipe pressure in the cases where the leak amount of a measuring object is 1.0 L/min and 0.5 L/min as in FIG. 5, but the pipe volume is larger than in FIG. 5. In the graph, the vertical axis indicates the pipe pressure (MPa) and the horizontal axis indicates the pressure drop time(s). In FIG. 6, black circles are actual measured values of the pipe pressure repeatedly taken at a predetermined sampling interval for the leak amount of 1.0 L/min. In FIG. 6, L4 is a linear approximate equation graph calculated from the data of the pipe pressure between 0.5 MPa and 0.47 MPa, among the actual measured values indicated by the black circles. In FIG. 6, gray circles are actual measured values of the pipe pressure repeatedly taken at a predetermined sampling interval for the leak amount of 0.5 L/min. In FIG. 5, L3 is a linear approximate equation graph calculated from the data of the pipe pressure between 0.5 MPa and 0.47 MPa, among the actual measured values indicated by the gray circles.

As shown by L6 and L5 in FIGS. 5 and L3 and L4 in FIG. 6, even when the leak amount of the measuring object is the same, the larger the pipe volume, the smaller the pressure drop rate. The time it takes for the pressure drop amount of the pipe pressure to reach the pressure threshold value depends on the pipe volumes. For example, when the leak amount is 1.0 L/min, the time it takes for the pipe pressure to decrease from 0.5 MPa to 0.47 MPa is about 25 (s) in the case of a small pipe volume as indicated by L5 in FIG. 5, but about 40 (s) in the case of a large pipe volume as indicated by L4 in FIG. 6. Further, for example, when the leak amount is 0.5 L/min, the time it takes for the pipe pressure to decrease from 0.5 MPa to 0.47 MPa is about 45 (s) for the small pipe volume as indicated by L6 in FIG. 5, but about 80 (s) for the large pipe volume as indicated by L3 in FIG. 6. If the time threshold value is set based on the pipe having a larger pipe volume in FIG. 6, the pipe pressure of the pipe having a smaller pipe volume will decrease to a target value before the time threshold value is reached, as shown in FIG. 5, and the pressure measurement time will be longer than necessary. Thus, the gas leak detection apparatus 1 needs to set a suitable time threshold value for each pipe volume.

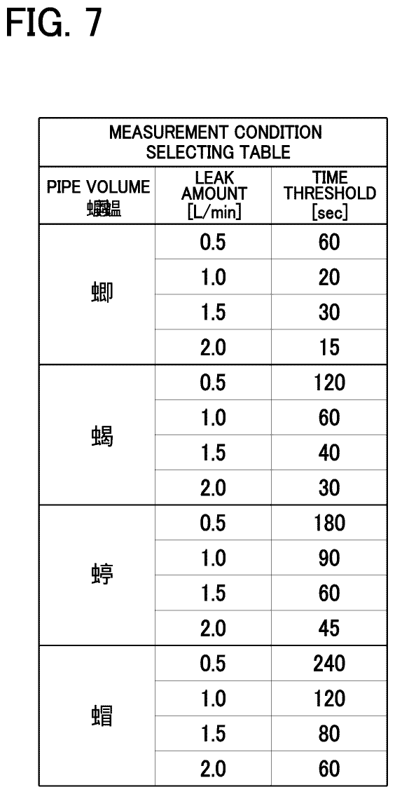

The gas leak detection apparatus 1 is therefore configured to store the measurement condition selecting table 73 shown in FIG. 7, having the pipe volumes, the leak amounts of measuring objects, and the time threshold values, which are associated with each other, and select the time threshold value based on the pipe volume and the leak amount of the measuring object. In the present embodiment, the gas leak detection apparatus 1 can select an appropriate time threshold value for a pipe that is a measuring object by matching the pipe volume V of the pipe and the leak determination threshold value set in advance by a user to determine a leak occurrence state of the pipe with the measurement condition selecting table 73 shown in FIG. 7.

For example, when the pipe volume is 1 (L) or lower and the leak determination threshold value is 0.5 (L/min), a time threshold value of 60 (sec) is selected. When the pipe volume is 1 (L) or lower and the leak determination threshold value is 1.0 (L/min), a time threshold value of 20 (sec) is selected. Further, for example, when the pipe volume is larger than 1 (L), but 2 (L) or less and the leak determination threshold value is 0.5 (L/min), a time threshold value of 120 (sec) is selected. When the pipe volume is larger than 1 (L), but 2 (L) or less and the leak determination threshold value is 1.0 (L/min), a time threshold value of 60 (sec) is selected.

### Procedure of Pipe-Volume Measuring Process

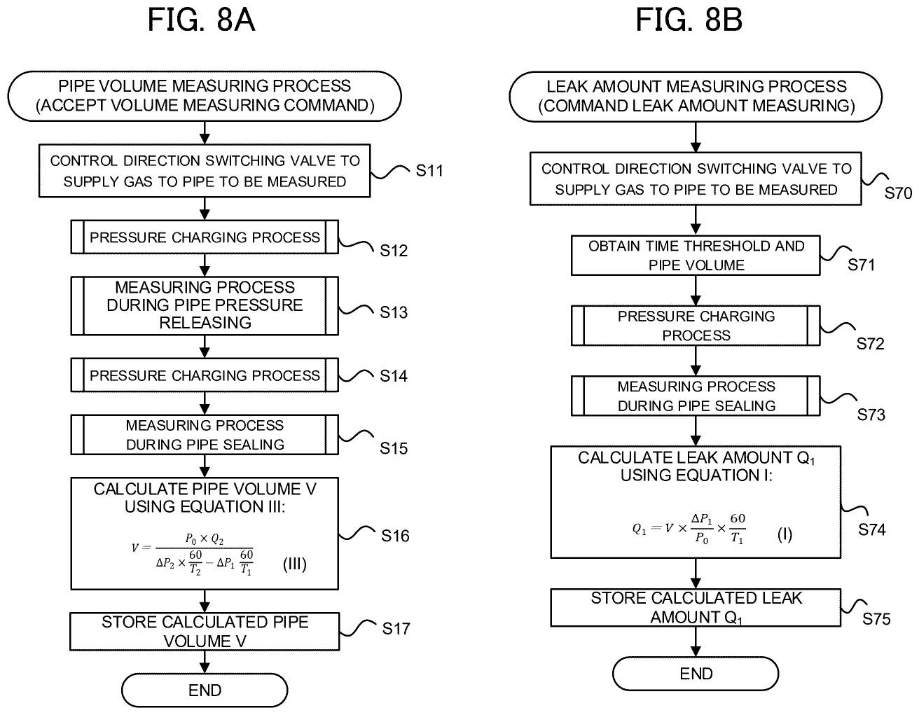

Next, the procedure of the above-described pipe-volume measuring process will be described with reference to FIG. 8A. When the gas leak detection apparatus 1 receives a pipe-volume measuring command from the user device 150, for example, the CPU 61 executes the pipe-volume measuring process shown in FIG. 8A based on the detection program 71 stored in the storage part 62. The pipe-volume measuring command may be accompanied by the data set or controlled by a user, such as measurement-object specifying information that specifies a pipe to be measured and original pressure of the gas supply source 110. The gas leak detection apparatus 1 may accept the pipe-volume measuring command from any device other than the user device 150. The gas leak detection apparatus 1 may start executing the measuring process from when it is detected that the pipe state has been changed to the sealing state and the releasing state based on the switching-valve state detected by the switching-valve state detection part 66 or from when the sealing switching valve 2 and the releasing switching valve 3 have been controlled by the user device 150 to set the pipe state to the sealing state and the releasing state.

The pipe volume remains the same unless the layout of the system in which the gas leak detection apparatus 1 is incorporated is changed. Accordingly, the pipe-volume measuring process needs only be performed at least once after the gas leak detection apparatus 1 is incorporated in the pneumatic system 100. The pipe-volume measuring process may be executed, for example, when the gas leak detection apparatus 1 is started for first time after being incorporated in the pneumatic system 100. The pipe-volume measuring process may be executed each time before start of execution of a leak-amount measuring process mentioned later. The pipe-volume measuring process may also be executed periodically, e.g., once a day or once a month, or may be performed during maintenance.

At the start of the pipe-volume measuring process, the direction switching valve 130 is located in the position to which the valve 130 has been switched just before. The sealing switching valve 2 and the releasing switching valve 3 are each turned OFF and placed in the exhaust position. The following description shows an example of measuring the pipe volume of the first branch pipe L12.

In the pipe-volume measuring process, firstly, the CPU 61 controls the switching operation of the direction switching valve 130 based on the measurement-object specifying information attached to the pipe-volume measuring command (S11).

For example, it is assumed that the measurement-object specifying information includes the information that the first branch pipe L12 shown in FIG. 1 is a measuring object. In this case, the CPU 61 energizes the first solenoid 136 of the direction switching valve 130 via the switching-valve control part 65 to switch the direction switching valve 130 the first output position. Thus, the gas supply pipe L11 is connected to the first branch pipe L12, allowing supply of compressed air to the first chamber 122 of the pneumatic actuator 120. In this position, no compressed air is supplied to the second chamber 123. The CPU 61 obtains, using the switching-valve state detection part 66, a control signal transmitted to the direction switching valve 130 and detects a switching valve state in which the direction switching valve 130 is located in the first output position.

Returning to FIG. 8A, the CPU 61 executes a pressure charging process (S12). In this process, the compressed air is supplied to the pipe to be measured to increase the pipe pressure.

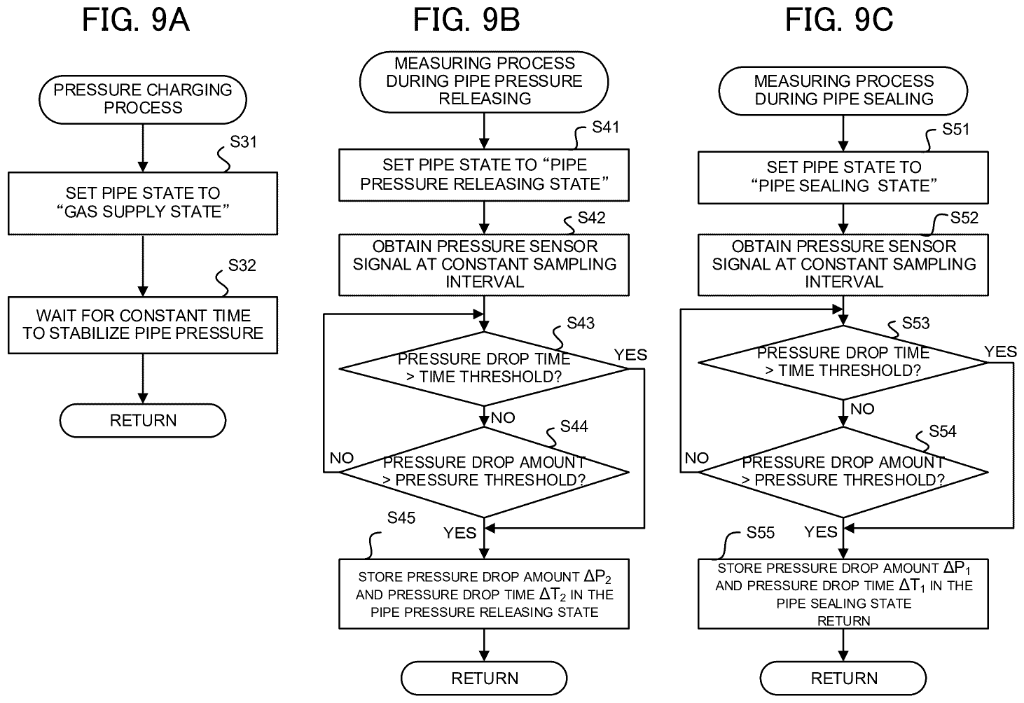

Specifically, as shown in FIG. 9A, the CPU 61 sets the pipe state to the “gas supply state” (S31). In other words, the CPU 61 energizes the solenoid 26 of the sealing switching valve 2 and the solenoid 36 of the releasing switching valve 3 via the switching-valve control part 65 to turn ON the sealing switching valve 2 and the releasing switching valve 3 respectively. The sealing switching valve 2 and the releasing switching valve 3 are each placed in the gas supply position. The compressed air fed from the gas supply source 110 is supplied to the first chamber 122 of the pneumatic actuator 120 through the gas supply pipe L11 and the first branch pipe L12, so that the pipe pressure of the first branch pipe L12 increases.

The CPU 61 waits for a constant time so that the pipe pressure of the first branch pipe L12 to be measured becomes stable (S32), and then advances to S13 in FIG. 8A. The pipe pressure rises to the original pressure of the gas supply source 110 and becomes stable thereat.

In S13 in FIG. 8A, the CPU 61 executes a measuring process during pipe pressure releasing. In this process, the first branch pipe L12 to be measured is forcibly exhausted and an “in-releasing pressure drop amount ΔP₂” indicating the amount of pressure drop during releasing, i.e., in the releasing state, and an “in-releasing pressure drop time ΔT₂” indicating the time of pressure drop during releasing, i.e., in the releasing state, are measured.

Specifically, as shown in FIG. 9B, the CPU 61 sets the pipe state to the “pipe pressure releasing state” (S41). In other words, the CPU 61 stops energization of the releasing switching valve 3 via the switching-valve control part 65 to turn OFF the releasing switching valve 3. The releasing switching valve 3 is thus switched from the gas supply position to the exhaust position, allowing the compressed air to be exhausted from the first branch pipe L12 through the orifice 5 placed in the exhaust port 33. The pipe pressure of the first branch pipe L12 starts decreasing according to exhaust from the orifice 5.

The gas supply pipe L11 is shut off by the releasing switching valve 3, and thus the switching state of the sealing switching valve 2 has no influence on the exhaust. Therefore, the CPU 61 may or may not output a control signal to the sealing switching valve 2.

When switching the pipe state to the pipe pressure releasing state and starting forcible exhaust from the exhaust port 33, the CPU 61 obtains a pressure sensor signal of the pressure sensor 4 at a constant sampling interval using the pressure-sensor detection part 67 (S42). That is, the CPU 61 starts measurement of the pressure drop amount and measurement of the pressure drop time. The CPU 61 determines whether or not the pressure drop time exceeds the time threshold value every time when obtaining the pressure sensor signal (S43). When it is determined that the pressure drop time does not exceed the time threshold value (S43: NO), the CPU 61 calculates a difference between a pipe pressure at the start of pressure measurement and a current pipe pressure, as a pressure drop amount, and determines whether this pressure drop amount is larger than the pressure threshold value (S44).

The detection program 71 in the present embodiment calculates the pressure threshold value within a range of 10% or less of the original pressure of the gas in the gas supply source 110, which is attached to the pipe volume measuring command. The detection program 71 may store the calculated pressure threshold value in the storage part 62 and read out the stored pressure threshold value from the storage part 62 when executing the subsequent pipe-volume measuring process and a leak-amount measuring process to be mentioned later. Accordingly, repeated calculation of the pressure threshold value is avoided when the original pressure of compressed air is rarely changed, and a processing load of the gas leak detection apparatus 1 can be reduced. The detection program 71 uses a time threshold value uniformly set in advance or a time threshold value registered by a user in the main unit 6 via the user device 150.

When the pressure drop time does not exceed the time threshold value (S43: NO) and the pressure drop amount is not larger than the pressure threshold value (S44: NO), the CPU 61 returns to the process in S43 and continues to measure the pressure drop time and the measurement of the pressure drop amount. When the pressure drop time exceeds the time threshold value (S43: YES), the CPU 61 terminates the pressure measurement and advances to S45, without determining whether the pressure drop amount is larger than the pressure threshold value, that is, by skipping S44. When the pressure drop time does not exceed the time threshold value (S43: NO) and the pressure drop amount is larger than the pressure threshold value (S44: YES), the CPU 61 terminates the pressure measurement and advances to S45. The processes in S43 and S44 are one example of measurement conditions of the disclosure.

In S45, the CPU 61 temporarily stores a pressure drop amount ΔP₂ and a pressure drop time ΔT₂ at the time when the pressure measurement is terminated, in the storage part 62. Hereinafter, the pressure drop amount ΔP₂ and the pressure drop time ΔT₂, which are stored in S45 in the pipe-volume measuring process, are also referred to as an in-releasing pressure drop amount ΔP₂ and an in-releasing pressure drop time ΔT₂. The CPU 61 terminates the measuring process during the pipe pressure releasing and advances to S14 in FIG. 8A.

As shown in FIG. 8A, the CPU 61 executes a pressure charging process (S14) and then performs a measuring process during pipe sealing (S15). This pressure charging process in S14 is the same as that in S12 and its explanation is omitted. In this process, the pressure drop amount ΔP₁ and the pressure drop time T₁ are measured while the first branch pipe L12 to be measured is sealed.

Specifically, as shown in FIG. 9C, the CPU 61 sets the pipe state to the “pipe sealing state” (S51). That is, the CPU 61 does not energize the solenoid 26 of the sealing switching valve 2 and energizes the solenoid 36 of the releasing switching valve 3 via the switching-valve control part 65. The sealing switching valve 2 is thus turned OFF and placed in the exhaust position. The releasing switching valve 3 is thus turned ON and placed in the gas supply position. Since the sealing switching valve 2 shuts off the gas supply pipe L11, the first branch pipe L12 is sealed. Since the releasing switching valve 3 shuts off the exhaust port 33, no compressed air in the first branch pipe L12 is exhausted from the exhaust port 33. At that time, if the first branch pipe L12 has a leak, the compressed air leaks from a leak site and the pipe pressure of the first branch pipe L12 starts to decrease. On the other hand, if the first branch pipe L12 has no leak, the compressed air does not leak from the first branch pipe L12 and the pipe pressure is maintained.

The CPU 61 obtains a pressure sensor signal at a constant sampling interval (S52). The CPU 61 then determines whether or not the pressure drop time exceeds the time threshold value (S53) and whether or not the pressure drop amount is larger than the pressure threshold value (S54). The processes in S52 to S54 are the same as those in S42 to S44 and their explanations are omitted. The pressure threshold values and the time threshold values used in S53 and S54 are the same as the pressure threshold values and the time threshold values used in S43 and S44.

In S55, the CPU 61 temporarily stores the pressure drop amount ΔP₁ and the pressure drop time T₁ at the time when the pressure measurement is terminated. Hereinafter, the pressure drop amount ΔP₁ and the pressure drop time T₁, which are stored in S55 of the pipe-volume measuring process will be also referred to as an “in-sealing pressure drop amount ΔP₁” indicating the amount of pressure drop during sealing, i.e., in the sealing state, and an “in-sealing pressure drop time T₁” indicating the time of pressure drop during sealing, i.e., in the sealing state. The CPU 61 terminates the measuring process during pipe sealing and advances to S16 in FIG. 8A.

In S16 in FIG. 8A, the CPU 61 calculates the pipe volume V using the foregoing equation III. Specifically, the CPU 61 estimates a leak amount Q₂ from the orifice 5 by matching the type of the orifice 5 installed in the releasing switching valve 3 and the pipe pressure measured by the pressure sensor 4 at the start time of pressure measurement with the orifice leak information 72. For example, when the orifice 5 is a second orifice and the pipe pressure measured by the pressure sensor 4 at the start time of pressure measuring is 0.50 (MPa), the CPU 61 estimates the leak amount Q₂ from the orifice 5 to be 0.5 (L/min) based on L2 in FIG. 4. The CPU 61 reads out the in-releasing pressure drop amount ΔP₂, the in-sealing pressure drop amount ΔP₁, the in-releasing pressure drop time ΔT₂, and the in-sealing pressure drop time T₁ from the storage part 62, and substituting those data and the estimated value of the leak amount Q₂ into the equation III to calculate the pipe volume V of the first branch pipe L12.

The CPU 61 obtains, via the switching-valve state detection part 66, a control signal transmitted from the switching-valve control part 65 to the direction switching valve 130 and detects the “first output position” as the operating state of the direction switching valve 130. The CPU 61 stores the calculated pipe volume V of the first branch pipe L12 as the pipe volume information 74 into the storage part 62 by associating the pipe volume V with the “first output position” of the operating state of the direction switching valve 130 (S17). The process for detecting the operating state of the direction switching valve 130 in S17 is one example of a “first operating state detecting process” of the disclosure. The detected operating state of the direction switching valve 130 is one example of a “first operating state” of the disclosure. Thereafter, the CPU 61 terminates the pipe-volume measuring process.

When the CPU 61 receives a pipe volume measuring command accompanied by the measuring object specifying information that specifies the second branch pipe L13, for example, the CPU 61 calculates the pipe volume V of the second branch pipe L13 in the same manner as above and stores the calculated pipe volume V in association with a “second output position” of the operating state of the direction switching valve 130 into the storage part 62. Thus, the gas leak detection apparatus 1 can measure and store a pipe volume for each pipe to be measured.

### Procedure of Leak-Amount Measuring Process

The procedure of the foregoing leak-amount measuring process will be described below with reference to FIG. 8B. When the gas leak detection apparatus 1 receives a leak detecting command from the user device 150, for example, the CPU 61 executes the leak-amount measuring process shown in FIG. 8B based on the detection program 71 stored in the storage part 62. The leak detecting command may be accompanied by the data set or controlled by a user, such as the measuring object specifying information and the original pressure of the gas supply source 110.

If the pipe L10 has a leak, the pneumatic actuator 120 may not operate normally. The leak-amount measuring process will therefore be repeatedly performed after execution of the pipe-volume measuring process. For example, the leak-amount measuring process may be executed in response to a command from the user device 150 during shutdown of the pneumatic system, such as during lunch break or during the night. For example, the leak-amount measuring process may be executed at predetermined timings such as at the time of start-up of the pneumatic system 100 or once a week. The leak-amount measuring process may also be executed according to user operations, such as during maintenance.

At the start time of the leak-amount measuring process, the direction switching valve 130 is located in the position to which the valve 130 has been switched just before. The sealing switching valve 2 and the releasing switching valve 3 are each turned OFF and placed in the exhaust position. The following description shows an example of measuring the leak amount in the first branch pipe L12.

In the leak-amount measuring process, firstly, the CPU 61 switches the direction switching valve 130 to the first output position based on the measurement-object specifying information that designates the first branch pipe L12 (S70). The process in S70 is the same as that in S11 in FIG. 8A and its explanation is omitted. The CPU 61 obtains, via the switching-valve state detection part 66, the control signal transmitted from the switching-valve control part 65 to the direction switching valve 130 and detects the operating state of the direction switching valve 130.

The CPU 61 obtains the time threshold value and the pipe volume (S71). Specifically, the CPU 61 reads out the pipe volume V associated with the “first output position” of the operating position of the direction switching valve 130, detected in S70, from the pipe volume information 74 of the storage part 62, based on the first branch pipe L12 to be measured. The CPU 61 automatically selects the time threshold value by matching the pipe volume V of the first branch pipe L12 obtained from the storage part 62 and the leak determination threshold value set by a user with the measurement condition selecting table 73. When the gas leak detection apparatus 1 includes an operation unit that accepts user operations, the time threshold value may be manually selected by use of the operation unit. The CPU 61 may obtain the time threshold value by receiving the time threshold value selected on the user device 150.

The CPU 61 executes a pressure charging process to stabilize the pipe pressure in the pipe to be measured (S72). S72 is the same as S12 in FIG. 8A and its explanation is omitted.

The CPU 61 executes a measuring process during pipe sealing (S73). This process in S73 is performed in the same manner as in S15 in FIG. 8A. However, the time threshold value used in S73 is the time threshold value obtained in S71. Thus, the time threshold value used in the leak-amount measuring process is changed in value according to the pipe volume of the first branch pipe L12 to be measured and the leak determination threshold value set by the user. In the leak-amount measuring process, consequently, the pressure change can be measured appropriately. Hereinafter, the pressure drop amount ΔP₁ and the pressure drop time T₁, which are stored in the storage part 62 in S73 will also be referred to as an “in-detecting pressure drop amount ΔP₁” indicating the amount of pressure drop during detecting, i.e., in the detecting state, and an “in-detecting pressure drop time T₁” indicating the amount of pressure drop during detecting, i.e., in the detecting state.

The CPU 61 calculates the leak amount Q₁ from the first branch pipe L12 by the foregoing equation I (S74). Specifically, the CPU 61 calculates the leak amount Q₁ from the first branch pipe L12 by substituting the pipe volume V of the first branch pipe L12 obtained from the storage part 62 in S71, the in-detecting pressure drop amount ΔP₁ and the in-detecting pressure drop time T₁, both stored in the storage part 62 in S73, into the equation I.

The CPU 61 obtains the control signal transmitted from the switching-valve control part 65 to the direction switching valve 130, by use of the switching-valve state detection part 66, and obtains the “first output position” as the state of the direction switching valve 130. The CPU 61 stores the leak amount Q₁ calculated in S74, in association with the “first output position” obtained as the operating state of the direction switching valve 130 (S75), and terminates the leak-amount measuring process. The process of detecting the operating state of the direction switching valve 130 in S74 is one example of a “second operating state detecting process” of the disclosure. The detected operating state of the direction switching valve 130 is one example of a “second operating state” of the disclosure. The operating state of the direction switching valve 130 detected in S71 may be stored in the storage part 62 and further the leak amount Q₁ calculated in association with the stored operating state may be stored in the storage part 62.

When the CPU 61 receives, for example, a leak amount measuring command accompanied by the measuring object specifying information that designates the second branch pipe L13, the CPU 61 calculates the leak amount Q₁ from the second branch pipe L13 in the same manner as above, and stores this in the storage part 62 in association with the “second output position” of the operating state of the direction switching valve 130. Thus, the gas leak detection apparatus 1 can measure and store a leak amount Q₁ for each pipe to be measured.

### Output Process

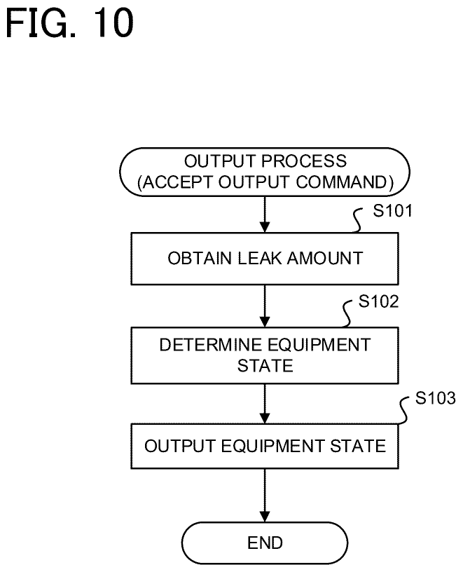

Referring to FIG. 10, the procedure of the output process for outputting detection results will be described below. Upon receipt of an output command, the CPU 61 reads out the leak amount Q₁ from the storage part 62 (S101). The output signal may be, for example, received from the user device 150 or accepted at the timing set in the detection program 71. As another example, the output command may be accepted at the timing when the leak-amount measuring process is completed.

The CPU 61 determines the equipment state based on the leak amount Q₁ read out in S101 (S102). This equipment state may be the leak amount Q₁ itself, for example. The CPU 61 compares each leak amount Q₁ and the leak determination threshold value, and determines that “there is a leak” when the leak amount Q₁ exceeds the leak determination threshold value or that “there is no leak” when leak amount Q₁ does not exceed the leak determination threshold value. This determination result may be included in the equipment state. The leak amount Q₁ is stored, for example, in association with the state of the direction switching valve 130. The gas leak detection apparatus 1 can therefore determine the presence/absence of a leak and the leak amount for each branch pipe, and thus can easily locate a leak site in the pipe L10.

The CPU 61 outputs the equipment state determined in S102 to the display part 63 to display it thereon (S103). The CPU 61 may also transmit the equipment state to the user device 150 via the communication part 64 to display it thereon. The displaying method may include, for example, lighting an LED lamp, displaying a list of the presence/absence of a leak and a leak amount for each pipe, or specifying and displaying a leak site in a circuit diagram of the pneumatic system 100 together with the leak amount. After outputting the equipment state, the CPU 61 terminates the output process. A user can check a leak site and a leak amount by looking at the equipment state displayed on the display part 63 or the user device 150.

### Example 1

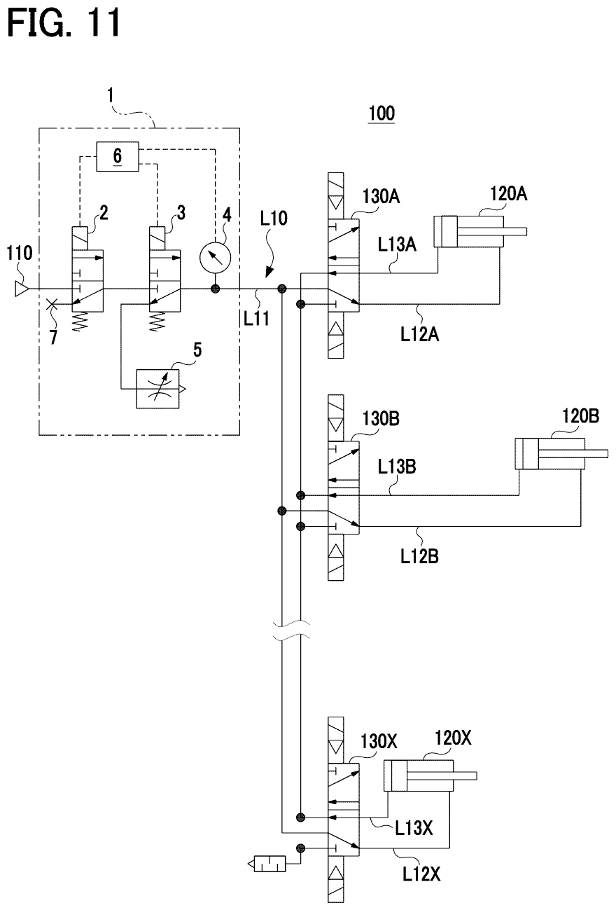

As shown in FIG. 11, for example, the pneumatic system 100 is configured such that a plurality of pneumatic actuators 120A, 120B . . . 120X are connected to a welding jig and used to uniformly hold down a workpiece with the welding jig. In this case, for the pipe L10, the gas supply pipe L11 branches into branch pipes L12A, L12B, . . . . L12X, L13A, L13B, . . . . L13X, twice the number of the pneumatic actuators 120. In the pipe L10, direction switching valves 130A, 130B . . . 130X are placed for each of the pneumatic actuators 120A, 120B . . . 120X.

To move up the welding jig to release the work, the direction switching valves 130A, 130B . . . 130X are switched to the first output position. To move down the welding jig to retain the work, the direction switching valves 130A, 130B . . . 130X are switched to the second output position. For example, if the branch pipe L12B has a leak, the pressing force of the pneumatic actuator 120B that retains the welding jig becomes weaker than the other pneumatic actuators, which may cause a welding failure. The pneumatic system 100 is therefore provided with the gas leak detection apparatus 1 placed in the gas supply pipe L11.

The pipe volumes of the branch pipes L12A, L12B, . . . . L12X, and L13A, L13B, . . . . L13X depend on the positions of the pneumatic actuators 120A, 120B . . . 120X. For example, the branch pipes L12B and L13B are longer in length and larger in pipe volume than the branch pipes L12A and L13A.

However, the gas leak detection apparatus 1 measures the pipe volumes V while the direction switching valves 130A, 130B . . . 130X are disposed in the first output position, and stores the measured pipe volumes V in the storage part 62 in association with the states of the direction switching valves 130A, 130B . . . 130X that are placed in the first output position. Further, for example, similar to the above, the gas leak detection apparatus 1 stores the measured pipe volumes V in the storage part 62 in association with the state of the direction switching valves 130A, 130B, . . . 130X in the second output position. Accordingly, the storage part 62 can separately ascertain the pipe volume V of the pipe for moving up the welding jig and the pipe volume V of the pipe for moving down the welding jig.

To detect the leak amount, the gas leak detection apparatus 1 reads out the pipe volume V associated with the state of the direction switching valves 130A, 130B . . . 130X placed in the first output position, and disposes those valves 130A and others in the first output position and then measures the in-detecting pressure drop amount ΔP₁ and the in-detecting pressure drop time T₁, and calculates the leak amount Q₁. The gas leak detection apparatus 1 stores the calculated leak amount Q₁ in the storage part 62 in association with the state of the valves 130A and others placed in the first output position. Further, for example, similar to the above, the gas leak detection apparatus 1 disposes those valves 130A and others in the second output position and then calculates the leak amount Q₁, and stores this leak amount Q₁ in the storage part 62. Consequently, the gas leak detection apparatus 1 can detect the leak amount Q₁ and the presence/absence of a leak in the pipe for moving up the welding jig and the pipe for moving down the welding jig, separately, and determine the equipment state and easily locate a leak site even in a complicated circuit.

### Operations and Effects of Gas Leak Detection Apparatus

As described above, in the gas leak detection apparatus 1 in the first embodiment, the compressed air to be exhausted from the exhaust port 33 of the releasing switching valve 3 is controlled at a constant amount by the orifice 5 placed in the exhaust port 33. The leak amount from the orifice 5 and the pipe pressure are in a proportional relationship. The gas leak detection apparatus 1 can therefore estimate the leak amount from the orifice 5 from the pipe pressure even if a flowmeter or a flow control valve is not connected to the exhaust port 33. The gas leak detection apparatus 1 switches the pipe state of the pipe L10 using the sealing switching valve 2 and the releasing switching valve 3 to the “gas supply state”, the “pipe pressure releasing state”, and the “pipe sealing state”, measures the in-releasing pressure drop amount ΔP₂ and the in-sealing pressure drop amount ΔP₁, and calculates the pipe volume based on those measurement data and the leak amount Q₂ from the orifice 5 estimated from the pipe pressure. Further, the gas leak detection apparatus 1 switches the pipe state of the pipe L10 using the sealing switching valve 2 and the releasing switching valve 3 to the “gas supply state” and the “pipe sealing state”, measures the in-sealing pressure drop amount ΔP₁, and calculates the leak amount Q₁ from the pipe L10 based on that measurement data and the calculated pipe volume. According to the gas leak detection apparatus 1 in the first embodiment, consequently, even if the exhaust port 33 is not connected to a flowmeter or a flow control valve, it is possible to calculate the pipe volume V from only the pressure measured by the pressure sensor 4, and detect a gas leak based on the calculated pipe volume V, resulting in reduced apparatus size.

In the pipe-volume measuring process or the leak-amount measuring process, even if the pressure drop time does not exceed the time threshold value, the gas leak detection apparatus 1 in the first embodiment terminates the measurement of the pressure drop amount when the pressure drop amount becomes larger than the pressure threshold value. The gas leak detection apparatus 1 can therefore terminate the measurement of the pressure drop amount before an error between the estimated value of the leak amount from the orifice 5 or the measuring object and the actual leak amount from the orifice 5 or the measuring object becomes large. Thus, the measurement accuracy of the pipe volume V and the leak amount Q₁ can be improved.

The gas leak detection apparatus 1 in the first embodiment can calculate the leak amount Q₁ based on an optimal time threshold value by selecting the time threshold value from the measurement condition selecting table 73 according to the pipe volume V and the leak determination threshold value. Thus, the measurement accuracy of the leak amount Q₁ can be improved.

In the gas leak detection apparatus 1 in the first embodiment, the sealing switching valve 2 is provided separately from the direction switching valve 130. This apparatus can therefore measure the pipe volume V and the leak amount Q₁ per pipe with a small number of devices and easily locate a leak site.

### Second Embodiment

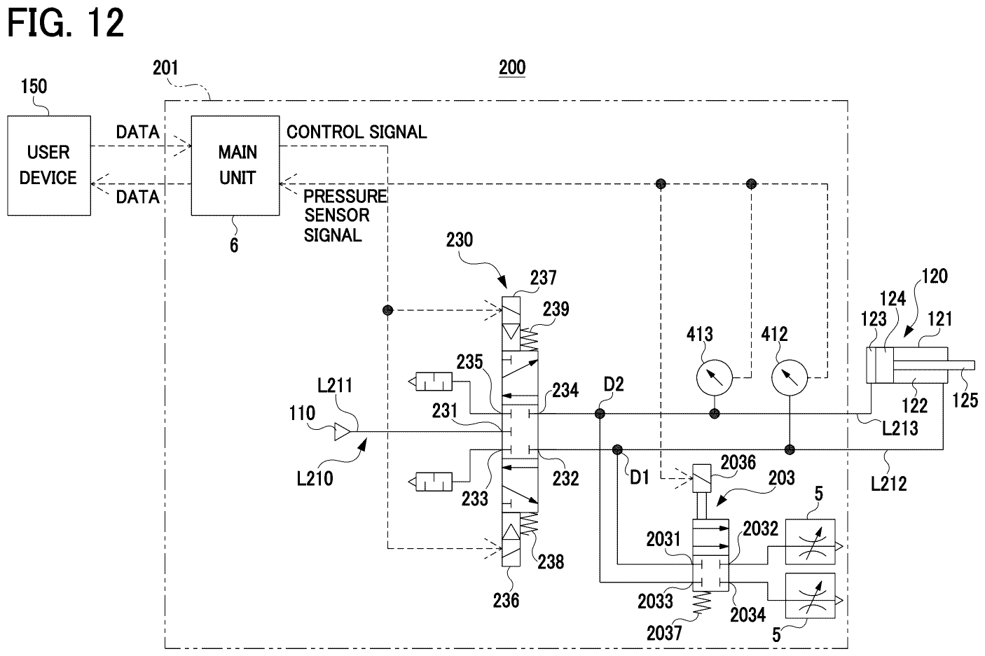

Next, a gas leak detection apparatus in a second embodiment will be described below. A gas leak detection apparatus 201 in this embodiment shown in FIG. 12 includes a direction switching valve 230 that is placed in a first branch pipe L212 and a second branch pipe L213 and has the function of switching a flow of compressed air and the function of sealing the pipe or pipes. This point differs from the gas leak detection apparatus 1 in the first embodiment in which the sealing switching valve 2 separate from the direction switching valve 130 for switching a flow of compressed air is placed in the gas supply pipe L11 and has the function of sealing the pipe or pipes. In the following description, differences from the first embodiment are focused on, and identical or similar parts to those in the first embodiment are assigned the same reference signs as in the first embodiment and their details are appropriately omitted.

### Schematic Configuration of Gas Leak Detection Apparatus

As shown in FIG. 12, the gas leak detection apparatus 201 is placed in a pipe L210 of a pneumatic system 200 for operating the pneumatic actuator 120 by supplying compressed air from the gas supply source 110 to the pneumatic actuator 120.

The pneumatic system 200 is provided with a direction switching valve 230 and the pneumatic actuator 120. The direction switching valve 230 includes an input port 231, a first output port 232, a first exhaust port 233, a second output port 234, and a second exhaust port 235. The input port 231 is connected to the gas supply source 110 via an air supply pipe L211. The first output port 232 is connected to the first chamber 122 of the pneumatic actuator 120 via the first branch pipe L212. The second output port 234 is connected to the second chamber 123 of the pneumatic actuator 120 via the second branch pipe L213. The first exhaust port 233 and the second exhaust port 235 are open to the atmosphere.

The direction switching valve 230 operates to change a flow of compressed air by switching between a “first position”, a “second position”, and a “third position” according to energization of a first solenoid 236 and a second solenoid 237. In the first position, the input port 231 is connected to the first output port 232 and the second output port 234 is connected to the second exhaust port 235 to supply compressed air to the first branch pipe L212. In the second position, the input port 231, the first output port 232, and the second output port 234 are not connected to other ports to place both the first branch pipe L212 and the second branch pipe L213 in the sealing state. In the third position, the input port 231 is connected to the second output port 234 and the first output port 232 is connected to the first exhaust port 233 to supply compressed air to the second branch pipe L213. When the first solenoid 236 and the second solenoid 237 are not energized and are turned OFF, the direction switching valve 230 is urged by springs 238 and 239 and placed in the second position. FIG. 12 shows the direction switching valve 230 placed in the second position.

A switching valve 203 used for releasing (hereinafter, referred to as a “releasing switching valve 203”) is connected to the first branch pipe L212 and the second branch pipe L213. The releasing switching valve 203 includes a first input port 2031, a first exhaust port 2032, a second input port 2033, and a second exhaust port 2034. The first input port 2031 is connected to the first branch pipe L212. The second input port 2033 is connected to the second branch pipe L213. The first exhaust port 2032 and the second exhaust port 2034 are open to the atmosphere. The first exhaust port 2032 and the second exhaust port 2034 are each provided with an orifice 5.

In the first branch pipe L212 and the second branch pipe L213, pressure sensors 412 and 413 are respectively provided. The pressure sensor 412 is located downstream of a connecting point D1 at which the releasing switching valve 203 is connected to the first branch pipe L212. This pressure sensor 412 detects the pipe pressure of the first branch pipe L212. The pressure sensor 413 is located downstream of a connecting point D2 at which the releasing switching valve 203 is connected to the second branch pipe L213. This pressure sensor 413 detects the pipe pressure of the second branch pipe L213. The main unit 6 receives pressure sensor signals from the pressure sensors 412 and 413 and thus can separately obtain the pipe pressure of the first branch pipe L212 and the pipe pressure of the second branch pipe L213.

The releasing switching valve 203 switches between a “non-exhaust position” and an “exhaust position” according to energization of a solenoid 2036 to control exhaust of gas. In the non-exhaust position, the first input port 2031 and the second input port 2033 are not connected to the first exhaust port 2032 and the second exhaust port 2034 respectively, not allowing exhaust of gas from the first branch pipe L212 and the second branch pipe L213. In the exhaust position, the first input port 2031 is connected to the first exhaust port 2032 and the second input port 2033 is connected to the second exhaust port 2034, allowing exhaust of gas from the first branch pipe L212 and the second branch pipe L213. When the solenoid 2036 is energized and turned ON, the releasing switching valve 203 is placed in the exhaust position. When the solenoid 2036 is not energized and is turned OFF, the releasing switching valve 203 is placed in the non-exhaust position. FIG. 12 shows the releasing switching valve 203 placed in the non-exhaust position.

The gas leak detection apparatus 201 is provided with the direction switching valve 230, the releasing switching valve 203, and the pressure sensors 412 and 413, which are connected to the main unit 6. The direction switching valve 230 is one example of a “gas supply valve” of the disclosure and the releasing switching valve 203 is one example of an “exhaust valve” of the disclosure.

### Switching of Pipe State

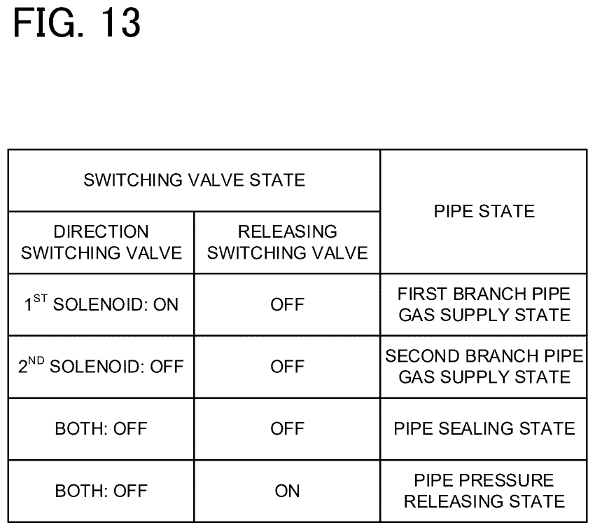

The above-described switching of the pipe state will be described below with reference to FIG. 13. The detection program 71 causes the gas leak detection apparatus 201 to control the switching operations of the direction switching valve 230 and the releasing switching valve 203 to switch the pipe state of the pipe L210 between a “first branch pipe gas supply state”, a “second branch pipe gas supply state”, a “pipe sealing state”, and a “pipe pressure releasing state”.

In the first branch pipe gas supply state, the first solenoid 236 is energized to turn ON the direction switching valve 230 and turn OFF the releasing switching valve 203 to allow compressed air to flow to the first branch pipe L212. Specifically, the detection program 71 can switch the pipe state of the pipe L210 to the first branch pipe gas supply state by placing the direction switching valve 230 in the first position and the releasing switching valve 203 in the non-exhaust position.

In the second branch pipe gas supply state, the second solenoid 237 is energized to turn ON the direction switching valve 230 and OFF the releasing switching valve 203, allowing compressed air to flow to the second branch pipe L213. Specifically, the detection program 71 can switch the pipe state of the pipe L210 to the second branch pipe gas supply state by placing the direction switching valve 230 in the third position and placing the releasing switching valve 203 in the non-exhaust position.

In the pipe sealing state, the direction switching valve 230 is turned OFF and the releasing switching valve 203 is turned OFF, forming a sealed space in the pipe L210. Specifically, the detection program 71 can switch the pipe state of the pipe L210 to the pipe sealing state by placing the direction switching valve 230 in the second position and placing the releasing switching valve 203 in the non-exhaust position.

In the pipe pressure releasing state, the direction switching valve 230 is turned OFF and the releasing switching valve 203 is turned ON, allowing compressed air to be exhausted from the pipe L10. Specifically, the detection program 71 can switch the pipe state of the pipe L210 to the pipe pressure releasing state by placing the direction switching valve 230 in the second position and placing the releasing switching valve 203 in the exhaust position.

### Procedure of Pipe-volume Measuring Process

The gas leak detection apparatus 201 in the second embodiment calculates a pipe volume according to the procedure shown in FIG. 8A. This is briefly explained below using an example where the first branch pipe L212 is a measuring object.

The CPU 61 of the gas leak detection apparatus 201 sets the pipe state of the pipe L210 to the “first branch pipe gas supply state” to supply compressed air to the first branch pipe L212 and stabilize the pipe pressure (S11, S12). In this case, the direction switching valve 230 is placed in the first position and the releasing switching valve 203 is placed in the non-exhaust position. The compressed air is thus supplied from the gas supply pipe L211 to the first chamber 122 of the pneumatic actuator 120 via the input port 231 and the first output port 232 of the direction switching valve 230 and the first branch pipe L212. This increases the pressure in the first branch pipe L212 and the pressure in the first chamber 122. Accordingly, the compressed air in the second chamber 123 is exhausted via the second branch pipe L213 and the second output port 234 and the second exhaust port 235 of the direction switching valve 230. The pneumatic actuator 120 operates very responsively in response to pressurization of the first chamber 122. The gas leak detection apparatus 201 can therefore smoothly stabilize the pipe pressure of the first branch pipe L212.

After the pipe pressure of the first branch pipe L212 is stabilized, the CPU 61 sets the pipe state of the pipe L210 to the “exhaust pressure releasing state” and measures and stores the in-releasing pressure drop amount ΔP₂ and the in-releasing pressure drop time ΔT₂ (S13). In this case, the direction switching valve 230 is placed in the second position and the releasing switching valve 203 is placed in the exhaust position. This allows the compressed air charged in the first branch pipe L212 to be exhausted from the first exhaust port 2032 of the releasing switching valve 203 via the orifice 5. Accordingly, the internal pressure of the first branch pipe L212 and the internal pressure of the first chamber 122 decreases. The second chamber 123 is communicated with the atmosphere via the second branch pipe L213, and the second input port 2033 and the second exhaust port 2034 of the releasing switching valve 203. Thus, as the pressure in the first chamber 122 decreases, ambient air flows in the second chamber 123. The pneumatic actuator 120 operates very responsively in response to exhaust from the first branch pipe L212. The gas leak detection apparatus 201 can therefore measure the in-releasing pressure drop amount ΔP₂ with accuracy.

When the condition that the pressure drop time exceeds the time threshold value and the condition that the pressure drop amount is larger than the pressure threshold value are satisfied, the CPU 61 stores the in-releasing pressure drop amount ΔP₂ and the in-releasing pressure drop time ΔT₂ in the storage part 62.

Further, the CPU 61 sets the pipe states of the pipe L210 to the “first branch pipe gas supply state” to supply compressed air to the first branch pipe L212 and stabilize the pipe pressure (S14).

Thereafter, the CPU 61 sets the pipe states of the pipe L210 to the “pipe sealing state”, and measures and stores the in-sealing pressure drop amount ΔP₁ and the in-sealing pressure drop time T₁ (S15). In this case, the direction switching valve 230 is placed in the second position and the releasing switching valve 203 is placed in the non-exhaust position. Thus, the compressed air charged in the first branch pipe L212 is not exhausted from the orifice 5. If the first branch pipe L212 has a leak in any site, the compressed air is released from only that leak site, causing a drop in the internal pressure of the first branch pipe L212 and a drop in the internal pressure of the first chamber 122. The second chamber 123 is communicated with the atmosphere via the second branch pipe L213, and the second output port 234 and the second exhaust port 235 of the direction switching valve 230. Thus, if the internal pressures of the first branch pipe L212 and the first chamber 122 decrease due to a leak from the leak site, ambient air flows in the second chamber 123. The pneumatic actuator 120 operates responsively in response to the leak from the leak site. The gas leak detection apparatus 201 can therefore measure the in-sealing pressure drop amount ΔP₁ with accuracy.

The CPU 61 calculates the pipe volume V by substituting the leak amount Q₂ from the orifice 5 placed in the first exhaust port 2032 of the releasing switching valve 203, the measured in-releasing pressure drop amount ΔP₂, the in-releasing pressure drop time ΔT₂, the in-sealing pressure drop amount ΔP₁, and the in-sealing pressure drop time T₁ into the above-mentioned equation III (S16). The CPU 61 stores the calculated pipe volume V in the storage part 62, as the pipe volume information 74, in association with the state of the direction switching valve 230 (i.e., the first position) in S11 (S17). Accordingly, the pipe volume V of the first branch pipe L212 is stored in the storage part 62. Similarly, the gas leak detection apparatus 201 calculates the pipe volume V of the second branch pipe L213 and stores it in the storage part 62, as the pipe volume information 74, in association with the state of the direction switching valve 230.

### Procedure of Leak-Amount Measuring Process

The gas leak detection apparatus 201 in the second embodiment calculates the pipe volume according to the procedure shown in FIG. 8B. This is briefly explained below using an example where the first branch pipe L212 is a measuring object.

The CPU 61 of the gas leak detection apparatus 201 sets the pipe state of the pipe L210 to the “first branch pipe gas supply state” to supply compressed air to the first branch pipe L212 to stabilize the pipe pressure (S70, S72). Thereafter, the CPU 61 sets the pipe state of the pipe L210 to the “pipe sealing state” and measures and stores the in-detecting pressure drop amount ΔP₁ and the in-detecting pressure drop time ΔT₁ (S73).

The CPU 61 reads out the pipe volume V corresponding to the state of the direction switching valve 230 controlled in S70 from the storage part 62, and calculates the leak amount Q₁ by substituting the read pipe volume V, the measured in-detecting pressure drop amount ΔP₁, and the in-detecting pressure drop time ΔT₁ into the above-mentioned equation I (S74). The CPU 61 stores the calculated leak amount Q₁ in the storage part 62 in association with the state of the direction switching valve 230 controlled in S70 (S75).

### Example 2

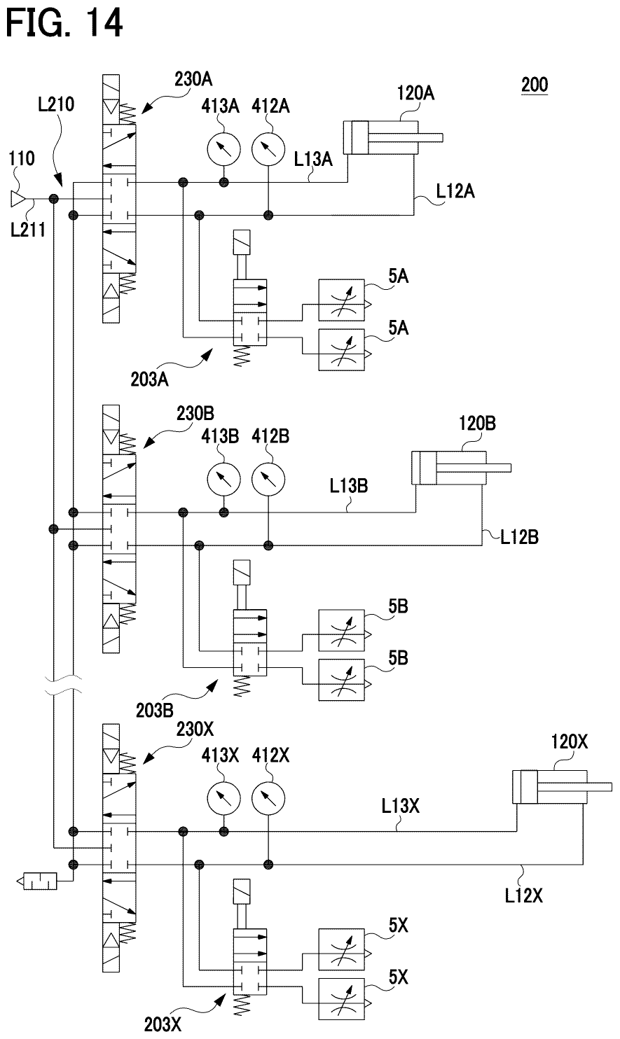

As shown in FIG. 14, for example, the pneumatic system 200 is configured such that a plurality of pneumatic actuators 120A, 120B, . . . 120X are connected to a welding jig and used to uniformly hold down a workpiece with a welding jig. In this case, for the pipe L210, the gas supply pipe L211 branches into branch pipes L212A, L212B, . . . . L212X, L213A, L213B, . . . . L213X, twice the number of the pneumatic actuators 120. In the pipe L210, direction switching valves 230A, 230B . . . 230X are placed for each of the pneumatic actuators 120A, 120B, . . . 120X. In the branch pipes L212A, L212B, . . . . L212X, L213A, L213B, . . . . L213X, pressure sensors 412A, 412B, . . . 412X, 413A, 413B, . . . 413X are respectively provided.

The main unit 6 is connected to the direction switching valves 230A, 230B, . . . 230X, the releasing switching valves 203A, 203B, . . . 203X, and the pressure sensors 412A, 412B, . . . 412X, 413A, 413B, . . . 413X to control the operations of the direction switching valves 230A, 230B, . . . 230X and the releasing switching valves 203A, 203B, . . . 203X.

When the branch pipe L12B is a measuring object, for example, the gas leak detection apparatus 201 switches the positions of the direction switching valve 230B and the releasing switching valve 203B, detects only a pressure detection signal of the pressure sensor 412B and measures the pipe volume V and the leak amount Q₁. At that time, the gas leak detection apparatus 201 places other direction switching valves 230 to the second position and other releasing switching valves 203 to the non-exhaust position so that no compressed air is supplied to and exhausted from the branch pipes other than the branch pipe L12B.

The gas leak detection apparatus 201 thus specifies the measuring object from the branch pipes L212A, L212B, . . . . L212X, L213A, L213B, . . . . L213X and measures the pipe volume V and the leak amount Q₁, and can easily locate a leak site.

### Operations and Effects of Gas Leak Detection Apparatus

As described above, in the gas leak detection apparatus 201 in the second embodiment, the compressed air to be exhausted from the first exhaust port 2032 and the second exhaust port 2034 of the releasing switching valve 203 is controlled at a constant amount by the orifices 5 respectively placed in the first exhaust port 2032 and the second exhaust port 2034. The leak amount from each orifice 5 and the pipe pressure of each branch pipe L212 or L213 are in a proportional relationship. The gas leak detection apparatus 201 can therefore estimate the leak amounts from the orifices 5 from the corresponding pipe pressures, even if a flowmeter or a flow control valve is not connected to each of the first exhaust port 2032 and the second exhaust port 2034. The gas leak detection apparatus 201 switches the pipe state of the pipe L210 using the direction switching valve 230 and the releasing switching valve 203 to the “gas supply state”, the “pipe pressure releasing state”, and the “pipe sealing state”, and measures the in-releasing pressure drop amount ΔP₂ and the in-sealing pressure drop amount ΔP₁, and calculates the pipe volume V based on those measurement data and the leak amount Q₂ from the orifice 5 estimated from the pipe pressure. Further, the gas leak detection apparatus 201 switches the pipe state of the pipe L210 using the direction switching valve 230 and the releasing switching valve 203 to the “gas supply state” and the “pipe sealing state”, measures the in-sealing pressure drop amount ΔP₁, and calculates the leak amount Q₁ from the pipe L210 based on those measurement data and the calculated pipe volume. According to the gas leak detection apparatus 201 in the second embodiment, consequently, even if the first exhaust port 2032 and the second exhaust port 2034 are not connected to a flowmeter or a flow control valve, it is possible to calculate the pipe volume V from only the pressures measured by the pressure sensors 412 and 413, and detect a gas leak based on the calculated pipe volume V, resulting in a reduced apparatus size.

In the gas leak detection apparatus 201 in the second embodiment, the direction switching valve 230 has the function of switching a flow of gas and the function of sealing the pipe or pipes to be measured. It is thus possible to calculate the pipe volume V and the leak amount Q₁ for each of the branch pipes L212A, L212B, L212X, . . . . L213A, L213B, . . . . L213X, and easily locate a leak site.

The foregoing embodiments are mere examples and give no limitation to the present disclosure. The present disclosure may be embodied in other specific forms without departing from the essential characteristics thereof. For instance, the gas to be detected by the gas leak detection apparatus 1 can be any gas other than compressed air as long as the gas is suitable for a system where the gas leak detection apparatus 1 is incorporated. For example, the system in which the gas leak detection apparatus 1 is incorporated is any system other than the pneumatic system 100. Specifically, the gas leak detection apparatus 1 may be incorporated in a semiconductor manufacturing system for supplying gas to a chamber to detect the leakage of purge gas. The sealing switching valve 2, the releasing switching valve 3, and the direction switching valve 230 may be manual valves so that flow paths are appropriately switched according to manual operations.

For example, the gas leak detection apparatus 1 can omit the processes in S11 and S70 when the user device 150 controls the direction switching valve 130. In this case, the gas leak detection apparatus 1 may be configured to detect a gas leak by obtaining the state of the direction switching valve 130 from the user device 150.

For example, the pressure threshold value may be any value uniformly set in advance or any value arbitrarily set using the user device 150 before execution of the pipe-volume measuring process. However, the gas leak detection apparatuses 1 and 201 can improve the measurement accuracy of the pipe volume and the leak amount by setting the pressure threshold value to 10% or less of the original pressure of the gas.

For example, the gas leak detection apparatuses 1 and 201 may not use the time threshold value selected from the measurement condition selecting table 73, in the leak-amount measuring process. However, the gas leak detection apparatuses 1 and 201 can calculate the leak amount Q₁ using an optimal time threshold value by selecting the time threshold value from the measurement condition selecting table 73 according to the pipe volume V and the previously set leak determination threshold value, and thus can improve the measurement accuracy of the leak amount Q₁.

For example, the gas leak detection apparatuses 1 and 201 may not store the calculated pipe volume V in the storage part 62 in association with the states of the direction switching valves 130 and 230. However, the gas leak detection apparatuses 1 and 201 can read and use the pipe volume V of the measuring object from the storage part 62 during leak amount measurement by storing the pipe volume V in the storage part 62 in association with the pipe to be measured, and thus can accurately detect a gas leak per pipe.

For example, the gas leak detection apparatuses 1 and 201 may not store the calculated leak amount Q₁ in the storage part 62 in association with the states of the direction switching valves 130 and 230. However, it is possible to notify a gas leak per pipe by storing the calculated leak amount Q₁ in the storage part 62 in association with the pipe under measurement and outputting the information about a leak in each pipe based on the stored leak amount Q₁.

For example, the leak amount shown in FIG. 7 does not have to be set by applying a linear approximate processing to the pressure sampling data, as in the graph obtained from the linear approximate values L5 and L6 shown in FIG. 5 and the approximate equation in FIG. 6. For example, the leak amount shown in FIG. 7 may be set by applying a filter processing other than the linear approximate processing, such as a smoothing processing. When the leak amount shown in FIG. 7 is set by applying the linear approximate processing or the filter processing such as the smoothing processing to the pressure sampling data, it is possible to suppress variations in pressure sampling data and enhance the measurement accuracy of the pipe volume V and the leak amount.

In any flowcharts disclosed in the embodiments, multiple processes in any number of steps can be reordered arbitrarily or executed in parallel within a scope where there is no inconsistency between the process contents.

The processes disclosed in the embodiments may be executed by a single CPU, multiple CPUs, a hard ware such as ASIC, alone or in combination. The processes disclosed in the embodiments may be realized in various aspects, such as a storage medium or a method that stores a program for executing the processes.

### REFERENCE SIGNS LIST

1, 201 Gas leak detection apparatus
2 Sealing switching valve
3 Releasing switching valve
4 Pressure sensor
5 Orifice
6 Main unit
230 Direction switching valve
203 Releasing switching valve
412, 413 Pressure sensor

What is claimed is:

1. A gas leak detection apparatus, which is placed in a pipe for supplying gas, to detect a gas leak in the pipe, the apparatus comprising:
a gas supply valve to control supply of the gas;
an exhaust valve placed on a downstream side of the gas supply valve, the exhaust valve being provided with an exhaust port and to control exhaust of the gas from the exhaust port;
an orifice placed in the exhaust port to control an exhaust flow rate at a constant amount;
a pressure sensor placed on a downstream side of the exhaust valve to measure a pipe pressure that is an internal pressure of the pipe; and
a controller connected to the pressure sensor, the gas supply valve, and the exhaust valve to control operations of the gas supply valve and the exhaust valve,
wherein the controller switches a pipe state of the pipe between:
a gas supply state to supply the gas to the pipe to be measured by causing the gas supply valve to supply the gas and not causing the exhaust valve to exhaust the gas,
a pipe sealing state to seal the pipe to be measured by causing the gas supply valve to shut off the gas and not causing the exhaust valve to exhaust the gas, and
a pipe pressure releasing state to exhaust the gas from the pipe to be measured through the orifice by causing the gas supply valve to shut off the gas and causing the exhaust valve to exhaust the gas, and
the controller executes:
a pipe-volume measuring process in which
the pipe state is switched to the gas supply state to pressurize the pipe to be measured, and then the pipe state is switched to the pipe pressure releasing state, and an in-releasing pressure drop amount, indicating an amount of pressure drop of the pipe pressure in the pipe pressure releasing state, until a measurement condition is satisfied is measured by the pressure sensor, and further the pipe state is switched to the pipe supply state to pressurize the pipe to be measured, and then the pipe state is switched to the pipe sealing state, and an in-sealing pressure drop amount, indicating an amount of pressure drop of the pipe pressure in the pipe sealing state, until the measurement condition is satisfied is measured by the pressure senor, and a pipe volume of the pipe to be measured is calculated based on the in-sealing pressure drop amount, the in-releasing pressure drop amount, and a leak amount from the orifice estimated from the pipe pressure; and
a leak-amount measuring process in which
the pipe state is switched to the gas supply state to pressurize the pipe to be measured, and then the pipe state is switched to the pipe sealing state, and an in-detecting pressure drop amount, indicating an amount of pressure drop of the pipe pressure during detecting, until the measurement condition is satisfied is measured, and the leak amount of the gas in the pipe to be measured is calculated based on the pipe volume calculated in the pipe-volume measuring process and the in-detecting pressure drop amount.

2. The gas leak detection apparatus according to claim 1, wherein the measurement condition is to satisfy either a condition that a pressure drop time, indicating a period of time for measuring a pressure drop amount of the pipe pressure, exceeds a time threshold value or a condition that the pressure drop amount is larger than a pressure threshold value.

3. The gas leak detection apparatus according to claim 2, wherein the pressure threshold value is set at a value equal to or less than 10% of an original pressure of the gas.

4. The gas leak detection apparatus according to claim 2, including a measurement condition selecting table in which the time threshold value is stored in association with a pipe volume and a leak determination threshold value that is set in advance,
wherein the controller sets the time threshold value selected from the measurement condition selecting table to the time threshold value of the measurement condition used in the leak-amount measuring process.

5. The gas leak detection apparatus according to claim 3, including a measurement condition selecting table in which the time threshold value is stored in association with a pipe volume and a leak determination threshold value that is set in advance,
wherein the controller sets the time threshold value selected from the measurement condition selecting table to the time threshold value of the measurement condition used in the leak-amount measuring process.

6. The gas leak detection apparatus according to claim 1, further including a storage part,
wherein the controller executes a first operation detecting process to detect a first operating state of at least one direction switching valve according to a state of the pipe to be measured in the pipe-volume measuring process, and
wherein, in the pipe-volume measuring process, the controller stores the calculated pipe volume in the storage part in association with the first operating state detected in the first operation detecting process.

7. The gas leak detection apparatus according to claim 2, further including a storage part,
wherein the controller executes a first operation detecting process to detect a first operating state of at least one direction switching valve according to a state of the pipe to be measured in the pipe-volume measuring process, and
wherein, in the pipe-volume measuring process, the controller stores the calculated pipe volume in the storage part in association with the first operating state detected in the first operation detecting process.

8. The gas leak detection apparatus according to claim 3, further including a storage part,
wherein the controller executes a first operation detecting process to detect a first operating state of at least one direction switching valve according to a state of the pipe to be measured in the pipe-volume measuring process, and
wherein, in the pipe-volume measuring process, the controller stores the calculated pipe volume in the storage part in association with the first operating state detected in the first operation detecting process.

9. The gas leak detection apparatus according to claim 4, further including a storage part,
wherein the controller executes a first operation detecting process to detect a first operating state of at least one direction switching valve according to a state of the pipe to be measured in the pipe-volume measuring process, and
wherein, in the pipe-volume measuring process, the controller stores the calculated pipe volume in the storage part in association with the first operating state detected in the first operation detecting process.

10. The gas leak detection apparatus according to claim 6, wherein
the controller executes a second operation detecting process to detect a second operating state of the at least one direction switching valve according to a state of the pipe to be measured in the leak-amount measuring process,
in the leak-amount measuring process, the controller stores the calculated leak amount in the storage part in association with the second operating state detected in the second operation detecting process, and
the controller further executes an output process to output information related to a leak based on the leak amount stored in the storage part.

11. The gas leak detection apparatus according to claim 1, wherein
the pipe includes a gas supply pipe for supplying the gas and a plurality of branch pipes branching off from the gas supply pipe,
a direction switching valve is placed in the pipe to control a flow of the gas from the gas supply pipe to the plurality of branch pipes, and
the gas supply valve, the exhaust valve, and the pressure sensor are placed in the gas supply pipe.

12. The gas leak detection apparatus according to claim 1, wherein
the pipe includes a gas supply pipe for supplying the gas and a plurality of branch pipes branching off from the gas supply pipe,
a direction switching valve is placed in the pipe to control a flow of the gas from the gas supply pipe to the plurality of branch pipes,
the gas supply valve is the direction switching valve,
the exhaust valve is connected to the plurality of branch pipes connected to the direction switching valve, and
the pressure sensor includes a plurality of pressure sensors each placed in one of the plurality of branch pipes.
